(19) United States
(12) Patent Application Publication
(10) Pub. No.: US 2025/0184893 A1
(43) Pub. Date: Jun. 5, 2025

(54) METHOD AND DEVICE FOR TRANSMITTING OR RECEIVING FRAME IN WIRELESS LAN SUPPORTING EMLSR

(71) Applicant: Electronics and Telecommunications Research Institute, Daejeon (KR)

(72) Inventors: Sung Hyun HWANG, Daejeon (KR); Kyu Min KANG, Daejeon (KR); Yong Ho KIM, Incheon (KR); Ju Seong MOON, Osan-si, Gyeonggi-do (KR)

(21) Appl. No.: 18/842,021

(22) PCT Filed: Mar. 16, 2023
(86) PCT No.: PCT/KR2023/003510

§ 371 Date: Aug. 27, 2024

(30) Foreign Application Priority Data
Mar. 16, 2022 (KR) 10-2022-0032931
Dec. 19, 2022 (KR) 10-2022-0178723

(51) Int. Cl. H04W 52/02; H04L 5/00; H04W 74/00; H04W 74/0816

(52) U.S. Cl. CPC H04W 52/0229; H04L 5/0053; H04W 74/002; H04W 74/0816

(57) ABSTRACT

A method and a device for transmitting or receiving a frame in a wireless LAN supporting EMLSR are disclosed. A method of a first STA comprises the steps of: transitioning the operation state of the first STA from a listening operation state to an EMLSR operation state by considering a TBTT of a first AP; receiving a beacon frame from the first AP in the EMLSR operation state; when the beacon frame indicates that a data unit to be transmitted to the first STA exists in the first AP, transmitting a PS-Poll frame to the first AP; and receiving a data frame including the data unit from the first AP in the EMLSR operation state.

### TECHNICAL FIELD

The present disclosure relates to a wireless local area network (LAN) communication technique, and more particularly, to a technique for low-power communication of an enhanced multi-link signal radio (EMLSR) device.

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

However, since a multi-link operation is an operation not defined in the existing wireless LAN standard, it may be necessary to define detailed operations according to an environment in which the multi-link operation is performed. In particular, a device (e.g., station (STA)) supporting enhanced multi-link single radio (EMLSR) operations may wait for reception in a multi-link. The device supporting EMLSR operations may be referred to as an EMLSR device.

When an EMLSR device starts transmitting and receiving frame(s) in a single link, the EMLSR device may operate only in the single link. In other words, the EMLSR device cannot transmit/receive frame(s) in other links while performing frame transmission/reception in the single link. A time may be required for the EMLSR device to switch a transceiver between links. Therefore, multi-link data transmission/reception methods considering the single link operating characteristics of the EMLSR device may be required.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for transmitting and receiving a frame for an enhanced multi-link signal radio (EMLSR) supporting low-power operations.

### Technical Solution

A method of a first station (STA), according to a first exemplary embodiment of the present disclosure for achieving the above-described objective, may comprise: transitioning an operation state of the first STA from a listening operation state to an enhanced multi-link single radio (EMLSR) operation state in consideration of a target beacon transmission time (TBTT) of a first access point (AP); receiving, from the first AP, a beacon frame in the EMLSR operation state; in response to the beacon frame indicating that a data unit to be transmitted to the first STA exists in the first AP, transmitting a power saving (PS)-Poll frame to the first AP; and receiving, from the first AP, a data frame including the data unit in the EMLSR operation state.

The method may further comprise: in response to determining that transmission of the data unit is delayed after transmitting the PS-Poll frame, transitioning the operation state of the first STA from the EMLSR operation state to the listening operation state; receiving, from the first AP, an initial control frame in the listening operation state; and after receiving the initial control frame, transitioning the operation state of the first STA from the listening operation state to the EMLSR operation state, wherein the data frame is received by the first STA operating in the EMLSR operation state after receiving the initial control frame.

The initial control frame may be a multi-user (MU)-request-to-send (RTS) frame, a clear-to-send (CTS) frame as a response to the MU-RTS frame may be transmitted by the first STA, and the data frame may be received after transmitting the CTS frame.

When an acknowledgment (ACK) frame is received in response to the PS-Poll and the data frame is not received within a preset time from a reception time of the ACK frame, transmission of the data unit may be determined to be delayed.

When an ACK frame is received instead of the data frame in response to the PS-Poll frame, transmission of the data unit may be determined to be delayed.

When transmission of the data unit is determined to be delayed after transmitting the PS-Poll frame, the operation state of the first STA may be maintained in the EMLSR operation state for reception of the data frame.

The first STA and a second STA may be affiliated with a STA multi-link device (MLD), the STA MLD may be an EMLSR STA MLD, the first AP and a second AP may be affiliated with an AP MLD, the first STA and the first AP may operate in a first link, and the second STA and the second AP may operate in a second link.

When reception of the data unit in the first link is given priority and the second STA receives an initial control frame in the second link after the PS-Poll frame is transmitted in the first link, a response to the initial control frame may not be transmitted.

When the first STA is in the EMLSR operation state, a power saving (PS) state of the first STA may be an awake state, and when the first STA is in the listening operation state, the PS state of the first STA may be a doze state or the awake state.

A method of a first access point (AP), according to a second exemplary embodiment of the present disclosure for achieving the above-described objective, may comprise: transmitting a beacon frame including information indicating that a data unit to be transmitted to a first station (STA) exists in the first AP; receiving a power saving (PS)-Poll frame from the first STA operating in an enhanced multi-link single radio (EMLSR) operation state; and transmitting a data frame including the data unit to the first STA operating in the EMLSR operation state, wherein an operation state of the first STA is the EMLSR operation state or a listening operation state.

The method may further comprise: in response to determining that the operation state of the first STA has transitioned from the EMLSR operation state to the listening operation state after the PS-Poll frame is received, transmitting an initial control frame to the first STA operating in the listening operation state, wherein the data frame may be transmitted to the first STA operating in the EMLSR operation state, according to the initial control frame.

The initial control frame may be a multi-user (MU)-request-to-send (RTS) frame, a clear-to-send (CTS) frame as a response to the MU-RTS frame may be received from the first STA, and the data frame may be transmitted after receiving the CTS frame.

When an acknowledgment (ACK) frame is transmitted in response to the PS-Poll and the first AP does not transmit the data frame within a preset time from a transmission time of the ACK frame, the operation state of the first STA may be determined to have been transitioned from the EMLSR operation state to the listening operation state.

When the first AP transmits an ACK frame instead of the data frame in response to the PS-Poll frame, the operation state of the first STA may be determined to have been transitioned from the EMLSR operation state to the listening operation state.

A first station (STA), according to a third exemplary embodiment of the present disclosure for achieving the above-described objective, may comprise a processor, and the processor may cause the first STA to perform: transitioning an operation state of the first STA from a listening operation state to an enhanced multi-link single radio (EMLSR) operation state in consideration of a target beacon transmission time (TBTT) of a first access point (AP); receiving, from the first AP, a beacon frame in the EMLSR operation state; in response to the beacon frame indicating that a data unit to be transmitted to the first STA exists in the first AP, transmitting a power saving (PS)-Poll frame to the first AP; and receiving, from the first AP, a data frame including the data unit in the EMLSR operation state.

The processor may further cause the first STA to perform: in response to determining that transmission of the data unit is delayed after transmitting the PS-Poll frame, transitioning the operation state of the first STA from the EMLSR operation state to the listening operation state; receiving, from the first AP, an initial control frame in the listening operation state; and after receiving the initial control frame, transitioning the operation state of the first STA from the listening operation state to the EMLSR operation state, wherein the data frame may be received by the first STA operating in the EMLSR operation state after receiving the initial control frame.

The initial control frame may be a multi-user (MU)-request-to-send (RTS) frame, a clear-to-send (CTS) frame as a response to the MU-RTS frame may be transmitted by the first STA, and the data frame may be received after transmitting the CTS frame.

When transmission of the data unit is determined to be delayed after transmitting the PS-Poll frame, the operation state of the first STA may be maintained in the EMLSR operation state for reception of the data frame.

The first STA and a second STA may be affiliated with a STA multi-link device (MLD), the STA MLD may be an EMLSR STA MLD, the first AP and a second AP may be affiliated with an AP MLD, the first STA and the first AP may operate in a first link, and the second STA and the second AP may operate in a second link.

When reception of the data unit in the first link is given priority and the second STA receives an initial control frame in the second link after the PS-Poll frame is transmitted in the first link, a response to the initial control frame may not be transmitted.

### Advantageous Effects

According to the present disclosure, an EMLSR device may wait for reception of frame(s) (e.g., data frame(s)) in links corresponding to the number of antennas. When a frame is received in a first link, the EMLSR device can switch a radio chain to the first link in which the frame is received, and can quickly receive frames through a plurality of spatial streams in the first link. An EMLSR STA may configure a link to operate in the same link as an AP. The EMLSR STA may reconfigure the link according to the type of data and/or the urgency of communication. According to the reconfiguration of the link, communication can be performed without interruption.

### DESCRIPTION OF DRAWINGS

FIG. 1 is a conceptual diagram illustrating a first exemplary embodiment of a wireless LAN system.

FIG. 2 is a block diagram illustrating a first exemplary embodiment of a communication node constituting a wireless LAN system.

FIG. 3 is a conceptual diagram illustrating a first exemplary embodiment of a multi-link configured between multi-link devices (MLDs).

FIG. 4 is a sequence chart illustrating an association procedure of a station in a wireless LAN system.

FIG. 5 is a timing diagram illustrating a first exemplary embodiment of an operation method of a communication node based on EDCA.

FIG. 6 is a block diagram illustrating a first exemplary embodiment of an enhanced multi-link single radio (EMLSR) device in a wireless LAN.

FIG. 7 is a timing diagram illustrating a first exemplary embodiment of operation states of an EMLSR device.

FIG. 8A is a timing diagram illustrating a first exemplary embodiment for transmission and reception of beacon frames and groupcast frames in a WLAN supporting EMLSR.

FIG. 8B is a timing diagram illustrating a second exemplary embodiment for transmission and reception of beacon frames and groupcast frames in a WLAN supporting EMLSR.

FIG. 9A is a timing diagram illustrating a third exemplary embodiment for transmission and reception of beacon frames and groupcast frames in a WLAN supporting EMLSR.

FIG. 9B is a timing diagram illustrating a fourth exemplary embodiment for transmission and reception of beacon frames and groupcast frames in a WLAN supporting EMLSR.

FIG. 10A is a timing diagram illustrating a fifth exemplary embodiment for transmission and reception of beacon frames and groupcast frames in a WLAN supporting EMLSR.

FIG. 10B is a timing diagram illustrating a sixth exemplary embodiment for transmission and reception of beacon frames and groupcast frames in a WLAN supporting EMLSR.

FIG. 11A is a timing diagram illustrating a seventh exemplary embodiment for transmission and reception of beacon frames and groupcast frames in a WLAN supporting EMLSR.

FIG. 11B is a timing diagram illustrating an eighth exemplary embodiment for transmission and reception of beacon frames and groupcast frames in a WLAN supporting EMLSR.

FIG. 12 is a timing diagram illustrating a ninth exemplary embodiment for transmission and reception of beacon frames and groupcast frames in a WLAN supporting EMLSR.

FIG. 13 is a timing diagram illustrating a tenth exemplary embodiment for transmission and reception of beacon frames and groupcast frames in a WLAN supporting EMLSR.

FIG. 14 is a timing diagram illustrating an eleventh exemplary embodiment for transmission and reception of beacon frames and groupcast frames in a WLAN supporting EMLSR.

FIG. 15 is a timing diagram illustrating a twelfth exemplary embodiment for transmission and reception of beacon frames and groupcast frames in a WLAN supporting EMLSR.

FIG. 16 is a timing diagram illustrating a thirteenth exemplary embodiment for transmission and reception of beacon frames and groupcast frames in a WLAN supporting EMLSR.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’.

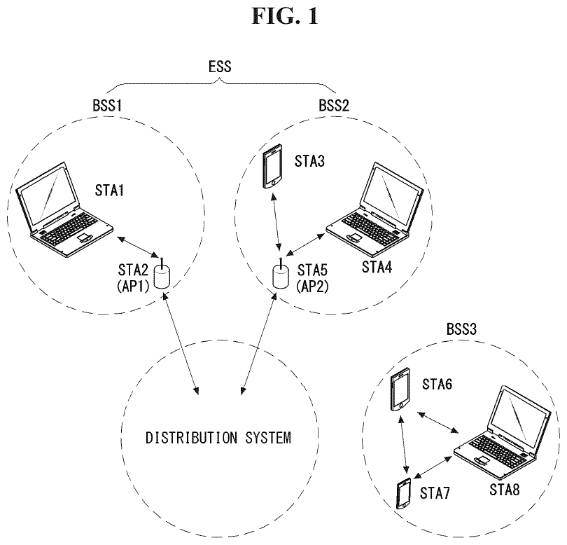

FIG. 1 is a conceptual diagram illustrating a first exemplary embodiment of a wireless LAN system.

Referring to FIG. 1, a wireless LAN system may include at least one basic service set (BSS). A BSS may refer to a set of stations (e.g., STA1, STA2 (AP1), STA3, STA4, STA5 (AP2), STA6, STA7, and STA8) that can communicate with each other through successful synchronization, and may not refer to a specific region. In exemplary embodiments below, a station performing functions as an access point may be referred to as an ‘access point (AP)’, and a station not performing functions as an access point may be referred to as a ‘non-AP station’ or a ‘station’.

The BSS may be classified into an infrastructure BSS and an independent BSS (IBSS). Here, a BSS1 and a BSS2 may mean infrastructure BSSs, and a BSS3 may mean an IBSS. The BSS1 may include a first station (STA1), a first access point (STA2 (AP1)) providing a distribution service, and a distribution system (DS) connecting a plurality of access points (STA2 (AP1) and STA5 (AP2)). In the BSS1, the first access point STA2 (AP1) may manage the first station STA1.

The BSS2 may include a third station (STA3), a fourth station (STA4), a second access point (STA5 (AP2)) providing a distribution service, and a DS connecting the plurality of access points (STA2 (AP1) and STA5 (AP2)). In the BSS2, the second access point STA5 (AP2) may manage the third station STA3 and the fourth station STA4.

The BSS3 may mean an IBSS operating in an ad-hoc mode. An access point, which is a centralized management entity, may not exist in the BSS3. That is, in the BSS3, the stations STA6, STA7, and STA8 may be managed in a distributed manner. In the BSS3, all stations STA6, STA7, and STA8 may refer to mobile stations, and since they are not allowed to access a DS, they may constitute a self-contained network.

The access points STA2 (AP1) and STA5 (AP2) may provide access to the DS for the stations STA1, STA3, and STA4 associated therewith via a wireless medium. In the BSS1 or BSS2, communications between the stations STA1, STA3, and STA4 are generally performed through the access points STA2 (AP1) and STA5 (AP2), but when direct links are established, direct communications between the stations STA1, STA3, and STA4 may be possible.

A plurality of infrastructure BSSs may be interconnected through a DS. The plurality of BSSs connected through the DS may be referred to as an extended service set (ESS). The communication nodes STA1, STA2 (AP1), STA3, STA4, and STA5 (AP2) included in the ESS may communicate with each other, and an arbitrary station (STA1, STA3, or STA4) may move from one BSS to another BSS within the same ESS while communicating without interruption.

The DS may be a mechanism for one access point to communicate with another access point, according to which an access point may transmit frames for stations associated with the BSS it manages, or transmit frames for an arbitrary station that has moved to another BSS. Also, the access point may transmit and receive frames to and from an external network such as a wired network. Such the DS may not necessarily have to be a network, and if it can provide a predetermined distribution service stipulated in the IEEE 802.11 standard, there is no restriction on its form. For example, the DS may be a wireless network such as a mesh network or a physical structure that connects the access points to each other. The communication nodes STA1, STA2 (AP1), STA3, STA4, STA5 (AP2), STA6, STA7, and STA8 included in the wireless LAN system may be configured as follows.

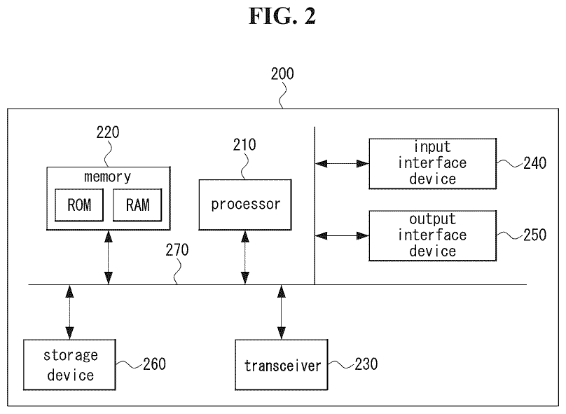

FIG. 2 is a block diagram illustrating a first exemplary embodiment of a communication node constituting a wireless LAN system.

Referring to FIG. 2, a communication node 200 may include at least one processor 210, a memory 220, and a transceiver 230 connected to a network to perform communications. The transceiver 230 may be referred to as a transceiver, a radio frequency (RF) unit, an RF module, or the like. In addition, the communication node 200 may further include an input interface device 240, an output interface device 250, a storage device 260, and the like. The respective components included in the communication node 200 may be connected by a bus 270 to communicate with each other.

However, the respective components included in the communication node 200 may be connected through individual interfaces or individual buses centering on the processor 210 instead of the common bus 270. For example, the processor 210 may be connected to at least one of the memory 220, the transceiver 230, the input interface device 240, the output interface device 250, and the storage device 260 through a dedicated interface.

The processor 210 may execute program commands stored in at least one of the memory 220 and the storage device 260. The processor 210 may refer to a central processing unit (CPU), a graphics processing unit (GPU), or a dedicated processor on which the methods according to the exemplary embodiments of the present invention are performed. Each of the memory 220 and the storage device 260 may be configured as at least one of a volatile storage medium and a nonvolatile storage medium. For example, the memory 220 may be configured with at least one of a read only memory (ROM) and a random access memory (RAM).

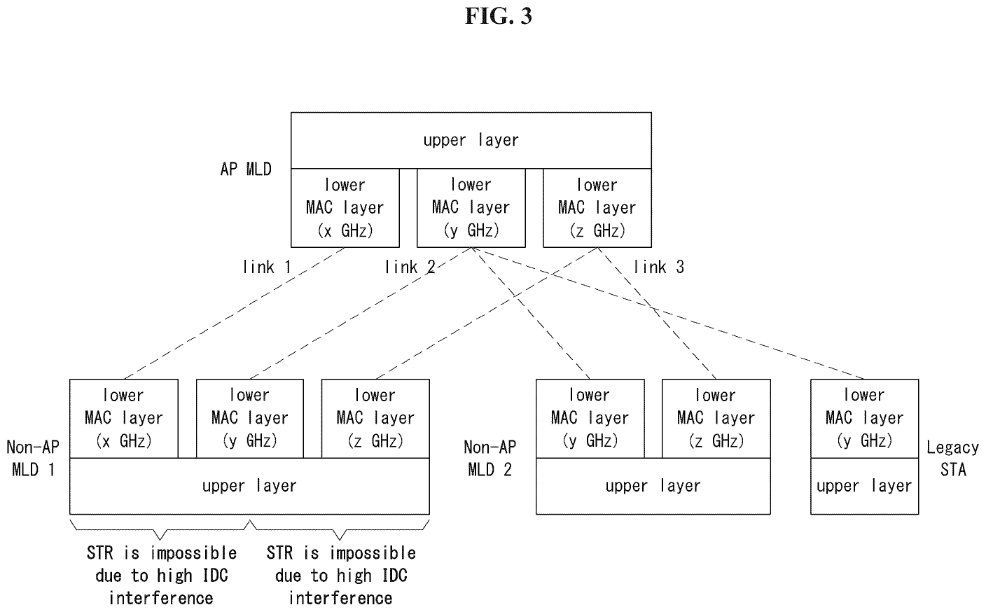

FIG. 3 is a conceptual diagram illustrating a first exemplary embodiment of a multi-link configured between multi-link devices (MLDs).

Referring to FIG. 3, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD). The AP of the AP MLD may mean an AP affiliated with the AP MLD. The STA of the STA MLD may mean a STA affiliated with the STA MLD.

The MLD may transmit and receive frames in multiple links by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 210 shown in FIG. 2). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 210 shown in FIG. 2).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

Each of the AP MLD and the STA MLD may have an MLD MAC address, and each of the AP and the STA operating in each link may have a MAC address. The MLD MAC address of the AP MLD may be referred to as an AP MLD MAC address, and the MLD MAC address of the STA MLD may be referred to as a STA MLD MAC address. The MAC address of the AP may be referred to as an AP MAC address, and the MAC address of the STA may be referred to as a STA MAC address. In a multi-link negotiation procedure, the AP MLD MAC address and the STA MLD MAC address may be used. The address of the AP and the address of the STA may be exchanged and/or configured in the multi-link negotiation procedure.

When the multi-link negotiation procedure is completed, the AP MLD may generate an address table and manage and/or update the address table. One AP MLD MAC address may be mapped to one or more AP MAC addresses, and corresponding mapping information may be included in the address table. One STA MLD MAC address may be mapped to one or more STA MAC addresses, and corresponding mapping information may be included in the address table. The AP MLD may identify address information based on the address table. For example, when a STA MLD MAC address is received, the AP MLD may identify one or more STA MAC addresses mapped to the STA MLD MAC address based on the address table.

In addition, the STA MLD may manage and/or update the address table. The address table may include ‘mapping information between the AP MLD MAC address and the AP MAC address(es)’ and/or ‘mapping information between the STA MLD MAC address and the STA MAC address(es)’. The AP MLD may receive a packet from a network, identify an address of a STA MLD included in the packet, identify link(s) supported by the STA MLD, and may identify STA(s) taking charge of the link(s) from the address table. The AP MLD may set STA MAC address(es) of the identified STA(s) as a receiver address(es), and may generate and transmit frame(s) including the receiver address(es).

Meanwhile, an association procedure in a wireless LAN system may be performed as follows.

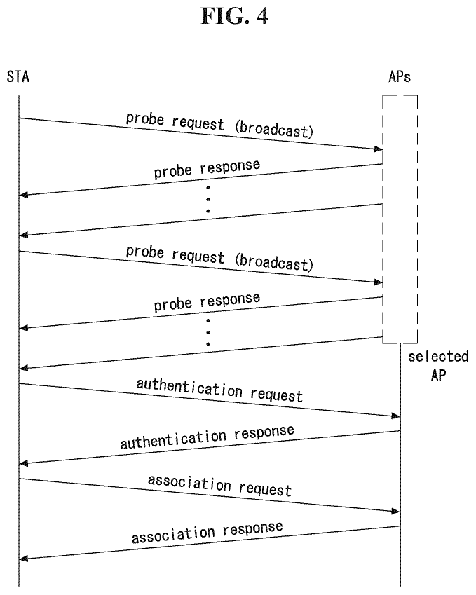

FIG. 4 is a sequence chart illustrating an association procedure of a station in a wireless LAN system.

Referring to FIG. 4, an association procedure of a STA in an infrastructure BSS may generally be divided into a probe step of detecting AP(s), an authentication step with detected AP(s), and an association step with the authenticated AP(s). The STA may be a STA MLD or a STA affiliated with the STA MLD, and the AP may be an AP MLD or an AP affiliated with the AP MLD.

The STA may detect neighboring APs using a passive scanning scheme or an active scanning scheme. When the passive scanning scheme is used, the STA may detect neighboring APs by overhearing beacons transmitted by APs. When the active scanning scheme is used, the STA may transmit a probe request frame, and may detect neighboring APs by receiving probe response frames that are responses to the probe request frame from the APs.

When the neighboring APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard, and may complete authentication with the AP by receiving an authentication response frame that is a response to the authentication request frame from the AP.

When the authentication with the AP is completed, the STA may perform an association step with the AP. In this case, the STA may select one AP among AP(s) with which the STA has performed the authentication step, and perform the association step with the selected AP. That is, the STA may transmit an association request frame to the selected AP, and may complete the association with the selected AP by receiving an association response frame that is a response to the association request frame from the selected AP.

Meanwhile, communication nodes (e.g., access points, stations, and the like) belonging to the wireless LAN system may perform transmission and reception operations of frames based on a point coordination function (PCF), hybrid coordination function (HCF), HCF controlled channel access (HCCA), distributed coordination function (DCF), enhanced distributed channel access (EDCA), and/or the like.

In the wireless LAN system, frames may be classified into a management frame, a control frame, and a data frame. The management frame may include an association request frame, association response frame, reassociation request frame, reassociation response frame, probe request frame, probe response frame, beacon frame, disassociation frame, authentication frame, deauthentication frame, action frame, and the like.

The control frame may include an acknowledgment (ACK) frame, block ACK request (BAR) frame, block ACK (BA) frame, power saving (PS)-Poll frame, request-to-send (RTS) frame, clear-to-send (CTS) frame, and the like. The data frame may be classified into a quality of service (QoS) data frame and a non-QoS data frame. The QoS data frame may refer to a data frame for which transmission according to a QoS is required, and the non-QoS data frame may indicate a data frame for which transmission according to a QoS is not required. The QoS data frame may include a QoS Null frame, and the QoS Null frame may not include a payload.

Meanwhile, in a wireless LAN system, a communication node (e.g., access point or station) may operate based on the EDCA scheme.

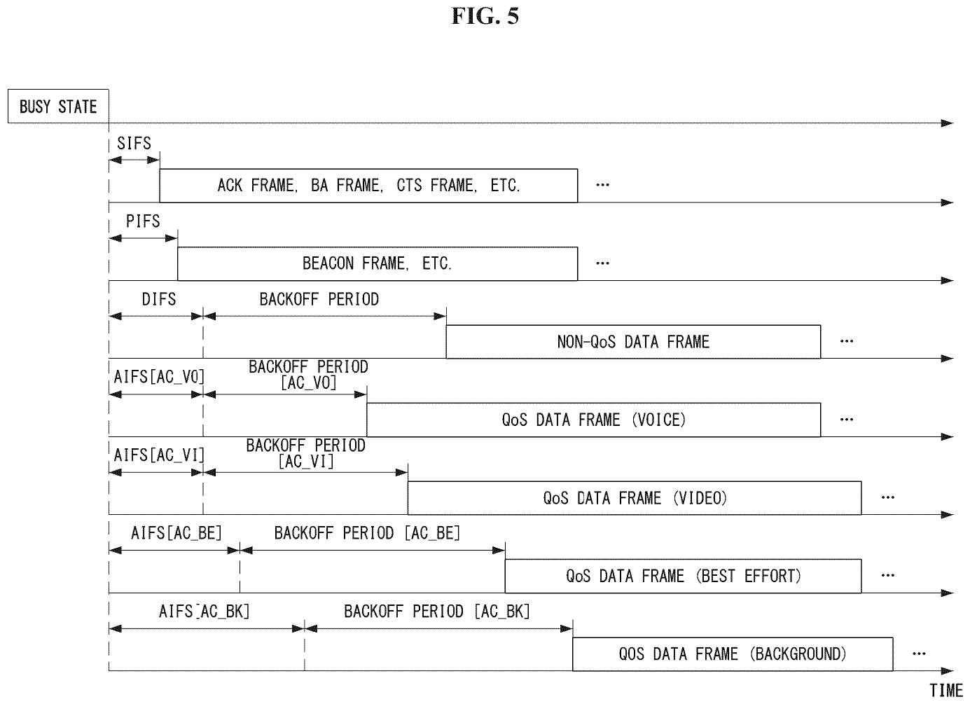

FIG. 5 is a timing diagram illustrating a first exemplary embodiment of an operation method of a communication node based on EDCA.

Referring to FIG. 5, a communication node desiring to transmit a control frame (or a management frame) may perform a channel state monitoring operation (e.g., carrier sensing operation) during a predetermined period (e.g., short interframe space (SIFS) or PCF IFS (PIFS)), and when the channel state is determined to be idle during the predetermined period (e.g., SIFS or PIFS), the communication node may transmit the control frame (or the management frame). For example, the communication node may transmit an ACK frame, a BA frame, a CTS frame, or the like when the channel state is determined to be idle during SIFS. Also, the communication node may transmit a beacon frame or the like when the channel state is determined to be idle during the PIFS. On the other hand, when it is determined that the channel state is busy during the predetermined period (e.g., SIFS or PIFS), the communication node may not transmit the control frame (or the management frame). Here, the carrier sensing operation may refer to a clear channel assessment (CCA) operation.

A communication node desiring to transmit a non-QoS data frame may perform a channel state monitoring operation (e.g., carrier sensing operation) during DCF IFS (DIFS), and when the channel state is determined to be idle during the DIFS, the communication node may perform a random backoff procedure. For example, the communication node may select a backoff value (e.g., a backoff counter) within a contention window according to the random backoff procedure and may perform a channel state monitoring operation (e.g., carrier sensing operation) during a period corresponding to the selected backoff value (hereinafter, referred to as ‘backoff period’). The communication node may transmit the non-QoS data frame when the channel state is determined to be idle in the backoff period.

A communication node desiring to transmit a QoS data frame may perform a channel state monitoring operation (e.g., carrier sensing operation) during an arbitration IFS (AIFS), and when the channel state is determined to be idle during the AIFS, the communication node may perform a random backoff procedure. The AIFS may be configured according to an access category (AC) of a data unit (e.g., protocol data unit (PDU)) included in the QoS data frame.

The AC of the data unit may be as shown in Table 1 below.

TABLE 1

| Priority | AC | Description |
|---|---|---|
| Lowest | AC_BK | Background |
| | AC_BE | Best effort |
| | AC_VI | Video |
| Highest | AC_VO | Voice |

AC_BK may indicate background data, AC_BE may indicate data transmitted in the best effort manner, AC_VI may indicate video data, AC_VO may indicate voice data. For example, the length of the AIFS for the QoS data frame corresponding to each of AC_VO and AC_VI may be configured to be equal to the length of the DIFS. The length of the AIFS for the QoS data frame corresponding to each of AC_BE and AC_BK may be configured to be longer than the length of the DIFS. Here, the length of the AIFS for the QoS data frame corresponding to AC_BK may be configured to be longer than the length of the AIFS for the QoS data frame corresponding to AC_BE.

In the random backoff procedure, the communication node may select a backoff value (e.g., a backoff counter) within a contention window according to the AC of the QoS data frame. The contention window according to the AC may be as shown in Table 2 below. CWₘᵢₙ may indicate a minimum value of the contention window, CWₘₐₓ may indicate a maximum value of the contention window, and each of the minimum value and the maximum value of the contention window may be represented by the number of slots.

TABLE 2

| AC | CWₘᵢₙ | CWₘₐₓ |
|---|---|---|
| AC_BK | 31 | 1023 |
| AC_BE | 31 | 1023 |
| AC_VI | 15 | 31 |
| AC_VO | 7 | 15 |

The communication node may perform a channel state monitoring operation (e.g., carrier sensing operation) in the backoff period and may transmit the QoS data frame when the channel state is determined to be idle in the backoff period.

Hereinafter, data transmission and reception methods in a wireless LAN system will be described. Even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a STA is described, an AP corresponding thereto may perform an operation corresponding to the operation of the STA. Conversely, when an operation of an AP is described, a STA corresponding thereto may perform an operation corresponding to the operation of the AP.

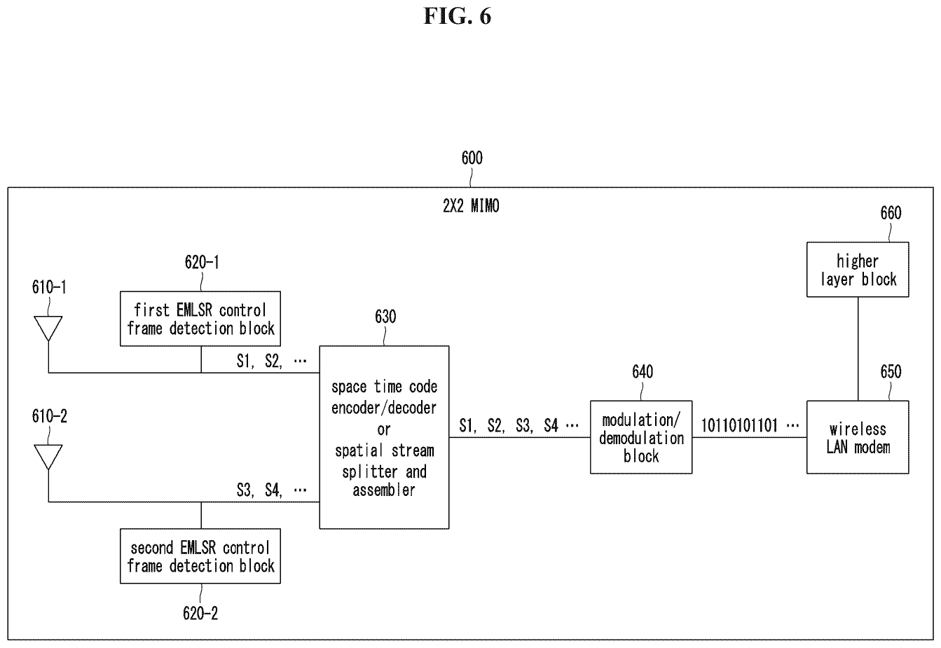

FIG. 6 is a block diagram illustrating a first exemplary embodiment of an enhanced multi-link single radio (EMLSR) device in a wireless LAN.

Referring to FIG. 6, an EMLSR device 600 may be an MLD supporting MLSR operations and/or EMLSR operations. The EMLSR device 600 may be referred to as an MLSR device. An EMLSR STA (or MLSR STA) may be a STA supporting MLSR operations and/or EMLSR operations, and an EMLSR AP (or MLSR AP) may be an AP supporting MLSR operations and/or EMLSR operations. The MLSR operation may mean an MLSR mode, and the EMLSR operation may mean an EMLSR mode. The EMLSR device 600 may include antennas 610-1 and 610-2, EMLSR control message detection blocks 620-1 and 620-2, a spatial stream processing block 630, a modulation and demodulation block 640, a wireless LAN modem 650, and/or a higher layer block 660. In exemplary embodiments, a spatial stream may be referred to as ‘SS’.

The EMLSR device 600 may include the plurality of antennas 610-1 and 610-2. The first antenna 610-1 may be used for a sensing operation and/or a reception operation of signals in a first link. The second antenna 610-2 may be used for a sensing operation and/or a reception operation of signals in a second link. A frequency at which the first link operates may be different from a frequency at which the second link operates. The sensing operation and/or reception operation performed by the first antenna and/or the second antenna may be referred to as ‘listening operation’. In order to simultaneously receive spatial stream signals, the first antenna 610-1 and the second antenna 610-2 may perform sensing operations and/or reception operations of signals in one of the first link and the second link. Among the plurality of antennas 610-1 and 610-2 included in the EMLSR device 600, one antenna may be a primary antenna, and the remaining antenna(s) may be secondary antenna(s). The primary antenna and secondary antenna(s) may be configured in advance. Alternatively, the primary antenna and the secondary antenna(s) may be configured in a negotiation procedure between the EMLSR device 600 and another device (e.g., AP MLD supporting EMLSR operations). An antenna performing a listening operation in a link having a low number (e.g., low index) may be configured as the primary antenna, and the remaining antenna(s) may be configured as the secondary antenna(s).

The first EMLSR control frame detection block 620-1 may be connected to or cooperate with the first antenna 610-1, and the second EMLSR control frame detection block 620-2 may be connected to or cooperate with the second antenna 610-2. Electromagnetic waves (e.g., signals) detected by the antennas 610-1 and 610-2 may be input to the EMLSR control frame detection blocks 620-1 and 620-2. The EMLSR control frame detection blocks 620-1 and 620-2 may determine whether the electromagnetic wave (e.g., signal) corresponds to a specific control frame (e.g., initial control frame). The EMLSR control frame detection blocks 620-1 and 620-2 may support only a predefined modulation and coding scheme (MCS) and may identify only predefined control frame formats. The formats of the predefined control frames (e.g., specific control frame, initial control frame) may include a request-to-send (RTS) frame, a multi-user (MU)-RTS trigger frame, and/or a buffer status report poll (BSRP) trigger frame.

When a specific control frame is detected in the EMLSR control frame detection blocks 620-1 and 620-2, the EMLSR device 600 may perform a reception operation for simultaneously receiving data through multiple streams by using as many spatial streams as the number of spatial streams (e.g., the number of antennas) supported by the EMLSR device 600. In order to perform the reception operation for receiving multiple spatial streams at the same time, a clear-to-send (CTS) frame may be transmitted through the first antenna 610-1 after a short inter-frame space (SIFS) from a time of detecting the specific control frame in the first link, and the second antenna 610-2 operating in the second link in which the specific control frame is not detected may switch to the first link and operate in the first link. In other words, a reception (RX) radio chain may be switched to operate in the first link. The RX radio chain may refer to a radio chain in the present disclosure. In addition, the radio chain may refer to a reception radio chain or a reception chain in the present disclosure. A radio chain may refer to a radio frequency (RF) chain. Switching of an operating link of the second antenna 610-2 (e.g., switching of the radio chain) may start after the time of detecting the specific control frame in the first link, and may be completed until a SIFS elapses after transmitting the CTS signal after a SIFS elapses. The multiple spatial streams (e.g., two spatial streams) may then be received through the plurality of antennas 610-1 and 610-2. The operation of receiving the MU-RTS trigger frame and switching the radio chain to receive the multiple spatial streams may be referred to as ‘EMLSR operation’.

When the specific control frame is detected by the EMLSR control frame detection blocks 620-1 and 620-2, and the reception procedure for the multiple spatial streams is performed, the spatial stream processing block 630 may perform a rearrangement operation for signals (e.g., symbols) received through the plurality of antennas 610-1 and 610-2. When a space time code is used, a single symbol may be generated into a plurality of symbols by a coding operation, and the plurality of symbols may be transmitted. The space time code may be an Alamouti code. The spatial stream processing block 630 may perform an operation of restoring the redundant symbols into the single symbol in a decoding procedure.

The output symbols of the spatial stream processing block 630 may be input to the modulation/demodulation block 640. The modulation/demodulation block 640 may generate bits by performing a demodulation operation on the symbols. The modulation/demodulation block 640 may perform a channel coding operation and/or a channel decoding operation. The output bits of the modulation/demodulation block 640 may be delivered to the wireless LAN modem 650. The wireless LAN modem 650 may perform medium access control (MAC) operations defined in the IEEE 802.11 standards. An output of the wireless LAN modem 650 may be delivered to the higher layer block 660. The higher layer block 660 may perform higher layer operations defined in the IEEE 802.11 standards. A series of operations performed after the specific control frame is detected by the EMLSR control frame detection block may be operations performed during the EMLSR operation. In the EMLSR device 600, a transmission operation may be performed in the reverse order of the above-described reception operation. The above-described antenna may refer to an RF chain that is a transmission and reception block including the antenna. The RF chain may be a hardware or/and logical structure including both a transmission (Tx) chain and an reception (Rx) chain.

Meanwhile, an EMLSR device may refer to an EMLSR MLD, an EMLSR STA MLD, an EMLSR AP MLD, an EMLSR STA, and/or an EMLSR AP. An operation state of the EMLSR device may be classified into a listening operation state and an EMLSR operation state. Alternatively, the operation state may be classified into a listening operation state, an EMLSR operation state, and a blindness state. In the listening operation state, the EMLSR STA may perform a reception operation for frame(s) (e.g., initial control frame) on EMLSR links. In the EMLSR operation state, the EMLSR STA may transmit and receive frames in a single link. The single link may be one of the EMLSR links. The EMLSR operation state may refer to a normal state, a normal operation state, a normal transmission state, a normal reception state, and/or a normal transmission/reception state. A period in the blindness state may be referred to as a blind period. In the present disclosure, a transmission time may mean a transmission start time and/or a transmission end time, and a reception time may mean a reception start time and/or a reception end time.

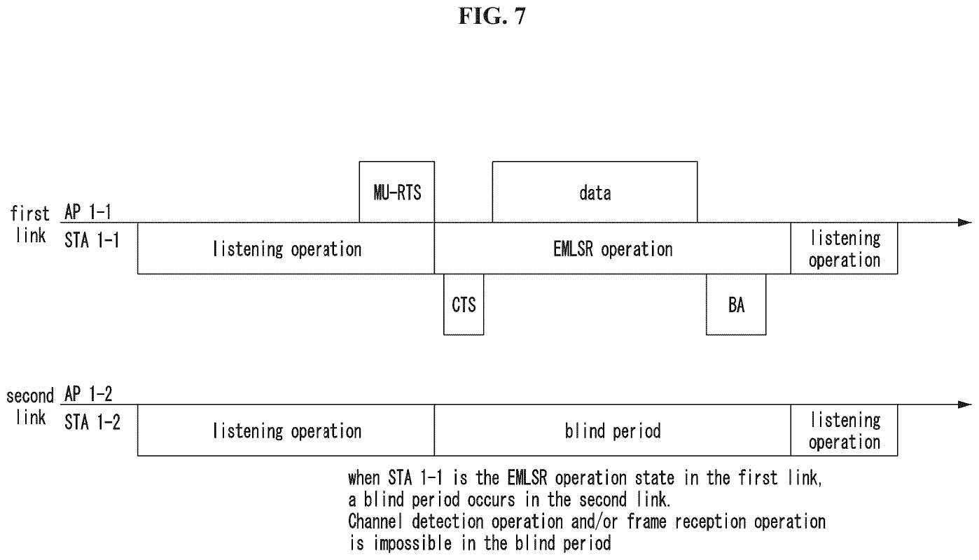

FIG. 7 is a timing diagram illustrating a first exemplary embodiment of operation states of an EMLSR device.

Referring to FIG. 7, an AP MLD and a STA MLD may operate in two links (e.g., first link and second link). The AP MLD and the STA MLD may operate in three or more links depending on hardware characteristics. An AP x-y may be affiliated with an AP MLD x and may operate in the y-th link. A STA x-y may be affiliated with a STA MLD x and may operate in the y-th link. Each of x and y may be a natural number. For example, an AP 1-1 may operate in the first link and may be affiliated with an AP MLD 1. An AP 1-2 may operate in the second link and may be affiliated with the AP MLD 1. A STA 1-1 may operate in the first link and may be affiliated with a STA MLD 1. A STA 1-2 may operate in the second link and may be affiliated with the STA MLD 1.

The STA MLD 1 may be an EMLSR STA MLD, and each of the STAs affiliated with the STA MLD 1 may be an EMLSR STA. An operation state of an EMLSR STA may be the listening operation state, the EMLSR operation state, or the blindness state in each of the first link and the second link. In the listening operation state, the EMLSR STA may receive only a predefined control frame (e.g., initial control frame). The initial control frame may be a trigger frame. The trigger frame may be an MU-RTS trigger frame and/or a BSRP trigger frame. The MU-RTS trigger frame may refer to an MU-RTS frame, and the BSRP trigger frame may refer to a BSRP frame.

In the EMLSR operation state, the EMLSR STA may normally transmit and receive frames using radio chains (e.g., all radio chains). A radio chain may mean a radio frequency (RF) chain. In a blind period, a channel detection operation, a frame reception operation, and/or a frame transmission operation may not be performed. The channel detection operation may refer to a clear channel assessment (CCA) operation. The STA 1-1 may operate in the listening operation state in the first link, and the STA 1-2 may operate in the listening operation state in the second link. In other words, the STA MLD 1 may operate in the listening operation state in EMLSR links. The STA 1-1 may receive an initial control frame (e.g., MU-RTS frame) from the AP 1-1 in the first link. In the present disclosure, the initial control frame may refer to an MU-RTS frame.

When the initial control frame is received, the STA 1-1 may transition the operation state from the listening operation state to the EMLSR operation state. In the EMLSR operation state, the STA 1-1 may transmit a CTS frame to the AP 1-1 in response to the MU-RTS frame (e.g., initial control frame). The AP 1-1 may receive the CTS frame from the STA 1-1. When the CTS frame of the STA 1-1 is received, the AP 1-1 may determine that the STA 1-1 operates in the EMLSR operation state. The AP 1-1 may transmit a data frame (e.g., physical layer protocol data unit (PPDU), MAC layer protocol data unit (MPDU), or aggregated MPDU (A-MPDU)) to the STA 1-1. The STA 1-1 may receive the data frame from the AP 1-1 and may transmit a response frame to the AP 1-1 in response to the data frame. The AP 1-1 may receive the response frame from the STA 1-1 in response to the data frame. In the present disclosure, the response frame may be an acknowledgment (ACK) frame or a block ACK (BA) frame.

When the STA 1-1 is in the EMLSR operation state, the operation state of the STA 1-2 may transition from the listening operation state to the blindness state. Accordingly, in the blindness state (e.g., blind period), the STA 1-2 may not be able to perform a channel detection operation, a frame reception operation, and/or a frame transmission operation. When a frame is not received during a transition waiting time Tw from a transmission time of the response frame of the STA 1-1, the STA 1-1 may transition the operation state from the EMLSR operation state to the listening operation state. The transition waiting time Tw may be (aSIFSTime (16us)+aSlotTime (9us)+aRxPHYStartDelay). A time Ts may be required for the transition of the operation state. Ts may refer to a state transition time. When the STA 1-1 transitions to the listening operation state, the STA 1-2 may also transition to the listening operation state. In other words, the operation state of the STA 1-1 may transition from the EMLSR operation state to the listening operation state, and in this case, the operation state of the STA 1-2 may transition from the blindness state to the listening operation state.

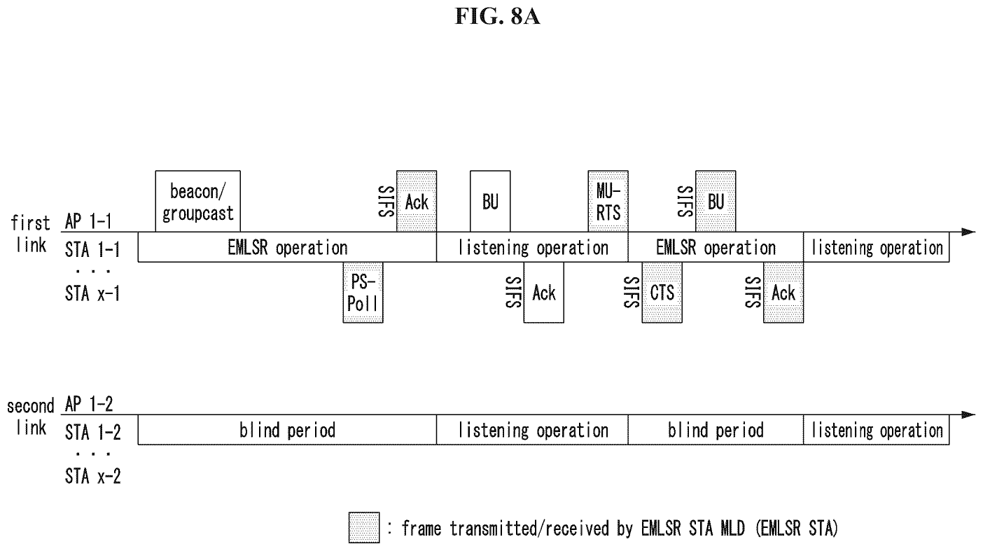

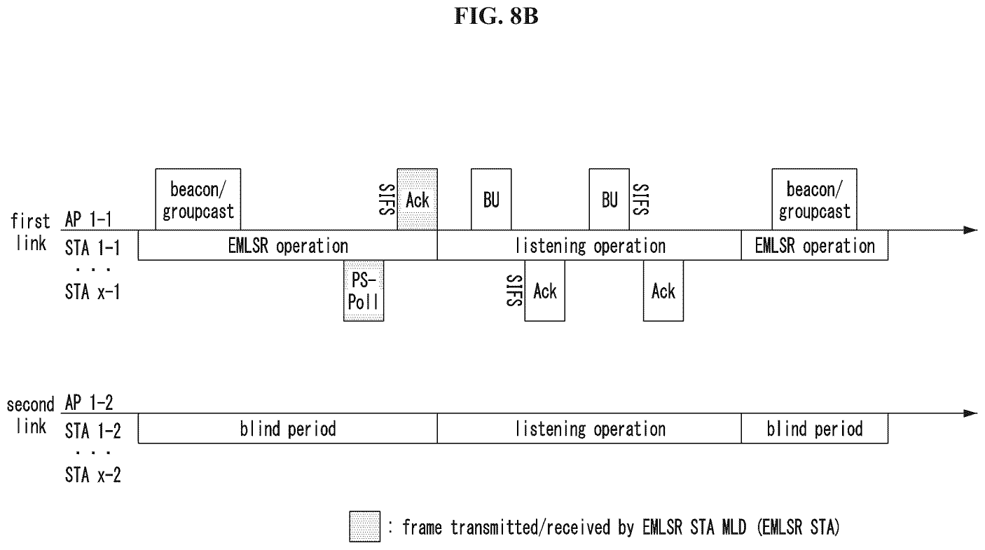

FIG. 8A is a timing diagram illustrating a first exemplary embodiment for transmission and reception of beacon frames and groupcast frames in a WLAN supporting EMLSR, and FIG. 8B is a timing diagram illustrating a second exemplary embodiment for transmission and reception of beacon frames and groupcast frames in a WLAN supporting EMLSR.

Referring to FIGS. 8A and 8B, a groupcast frame may refer to a frame transmitted in a groupcast scheme. The groupcast frame may refer to a group addressed frame. The STA MLD 1 may be an EMLSR STA MLD, and each of the STAs affiliated with the STA MLD 1 may be an EMLSR STA. The STA MLD 1 may know a target beacon transmission time (TBTT) of the AP 1-1 in the first link. The STA 1-1 may transition to the EMLSR operation state before the TBTT to receive a beacon frame in the first link. In other words, the operation state of the STA 1-1 may transition from the listening operation state to the EMLSR operation state in consideration of the TBTT of the AP 1-1. In the EMLSR operation state, the STA 1-1 may receive the beacon frame from the AP 1-1. The STA 1-1 may identify a traffic indication map (TIM) included in the beacon frame. When a bit corresponding to an association identifier (AID) of the STA MLD 1 is set to 1 in a virtual bitmap of the TIM, the STA 1-1 (e.g., STA MLD 1) may determine that a buffered unit (BU) to be transmitted to the STA MLD 1 exists in the AP MLD 1. In the present disclosure, a BU may refer to data, a data unit, a PPDU, an MPDU, an A-MPDU, and/or a data frame.

In this case, the STA 1-1 may not transition to the listening operation state and may perform a channel contention operation in the first link to transmit a PS-Poll frame. When a channel is acquired by the channel contention operation, the STA 1-1 may transmit a PS-Poll frame to the AP 1-1. The PS-Poll frame of the STA 1-1 may request transmission of the BU. The AP 1-1 may receive the PS-Poll frame from the STA 1-1. When the PS-Poll frame of the STA 1-1 is received, the AP 1-1 may determine that the STA 1-1 is able to receive the BU. The AP 1-1 may transmit a response frame (e.g., ACK frame) to the STA 1-1 in response to the PS-Poll frame. The response frame may be transmitted in the first link through which the PS-Poll frame is received. The STA 1-1 may receive the response frame from the AP 1-1.

The BU transmission operation (e.g., data transmission operation) of the AP 1-1 may be delayed according to a traffic condition in the first link. When the data frame (e.g., BU) is not received from the AP 1-1 within a preset time (e.g., SIFS) from a reception time of the response frame for the PS-Poll frame, the STA 1-1 may transition from the EMLSR operation state to the listening operation state. Alternatively, when the response frame is received instead of the data frame in response to the PS-Poll frame, the STA 1-1 may transition the operation state from the EMLSR operation state to the listening operation state. The STA 1-1 may determine that the BU transmission operation of the AP 1-1 is delayed based on the above-described operation, and accordingly, may transition from the EMLSR operation state to the listening operation state.

The AP MLD 1 may transmit the data frame (e.g., BU) to the STA MLD 1 through the AP 1-1 in the first link where the PS-Poll frame is received. Before the AP 1-1 transmits the BU to the STA 1-1, the AP 1-2 may not transmit a frame to the STA 1-2. When the response frame for the PS-Poll frame is received, the STA 1-1 may transition to the listening operation state after receiving the response frame. The time Ts may be required to transition the operation state of the STA 1-2 to the listening operation state. The time Ts may be a time required to switch a second antenna (e.g., radio module, radio chain, or RF chain) operating in the first link to the second link. The time Ts (e.g., antenna switching time) may not be required to transition the operation state of the STA 1-1 to the listening operation state. In other words, the STA 1-1 may transition to the listening operation state without an antenna switching time.

The STA 1-1 may stand by in the listening operation state in the first link through which the PS-Poll frame is transmitted. The AP 1-1 may transmit an initial control frame (e.g., MU-RTS frame) to the STA 1-1 before transmitting the BU to the STA 1-1 (e.g., EMLSR STA). The STA 1-1 may receive the MU-RTS frame from the AP 1-1 and may transmit a CTS frame to the AP 1-1 in response to the MU-RTS frame. The AP 1-1 may receive the CTS frame from the STA 1-1. The AP 1-1 may transmit the BU to the STA 1-1 after a SIFS from a reception time of the CTS frame. The AP 1-1 may transmit the BU to the STA 1-1 using multiple spatial streams supported by the STA MLD 1. The STA MLD 1 may support two or more multiple spatial streams.

Depending on traffic conditions or other circumstances, the AP 1-1 may not be able to transmit the BU to the STA 1-1 during a period from a transmission time of the beacon frame to a next TBTT. The STA 1-1 affiliated with the STA MLD 1 may transition to the EMLSR operation state in the next TBTT (or before the next TBTT) in the first link, and in the EMLSR operation state, the STA 1-1 may receive a beacon frame from the AP MLD 1. The STA 1-2 affiliated with the STA MLD 1 may transition to the EMLSR operation state in the next TBTT (or before the next TBTT) in the second link, and in the EMLSR operation state, the STA 1-2 may receive a beacon frame from the AP MLD 1. The AP MLD 1 may indicate whether a BU for the STA MLD 1 exists using a TIM of a beacon frame transmitted in the first link and/or the second link. When a BU for the STA MLD 1 does not exist in the AP MLD 1, a bit corresponding to the STA MLD 1 (e.g., AID of the STA MLD 1) in the TIM may be set to 0. When a BU for the STA MLD 1 exists in the AP MLD 1, the bit corresponding to the STA MLD 1 (e.g., AID of the STA MLD 1) in the TIM may be set to 1.

When the bit corresponding to the STA MLD 1 is set to 1 in the TIM of the beacon frame received from the AP MLD 1, the STA MLD 1 may transmit a PS-Poll frame in the first link and/or the second link. The AP MLD 1 may receive the PS-Poll frame from the STA MLD 1 and may transmit a response frame (e.g., ACK frame) to the STA MLD 1 in response to the PS-Poll frame. When the response frame of the AP MLD 1 is received, the STA MLD 1 may transition to the listening operation state. When the bit corresponding to the STA MLD 1 is set to 0 in the TIM of the beacon frame received from the AP MLD 1, the STA MLD 1 may transition to the listening operation state. In other words, when the bit corresponding to the STA MLD 1 is set to 0 in the TIM of the beacon frame received from the AP MLD 1, the STA MLD 1 may operate in the listening operation state in all EMLSR links.

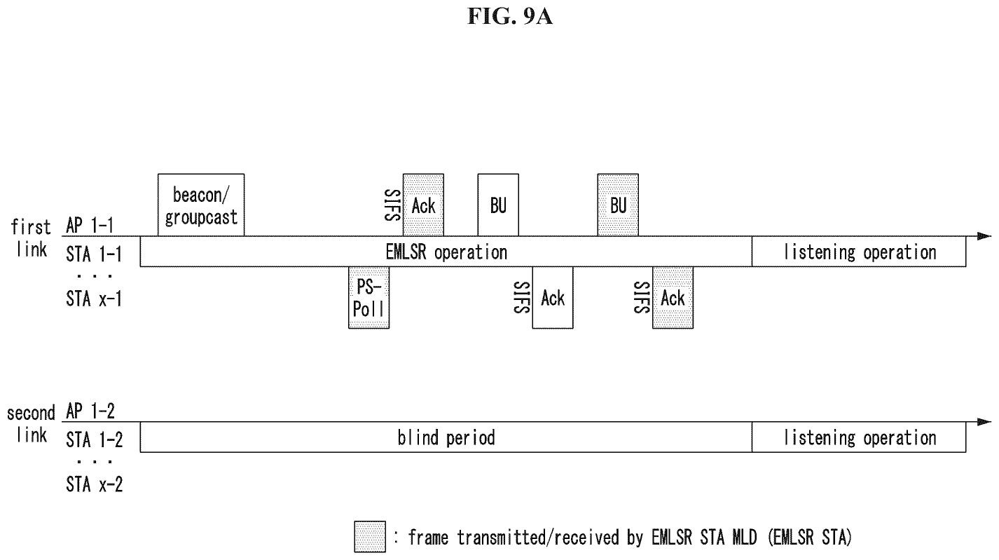

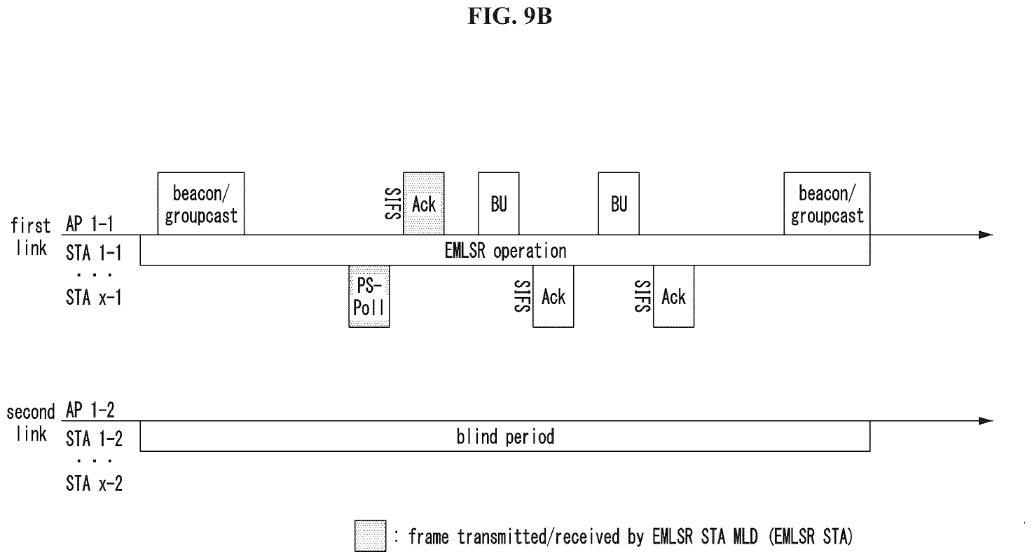

FIG. 9A is a timing diagram illustrating a third exemplary embodiment for transmission and reception of beacon frames and groupcast frames in a WLAN supporting EMLSR, and FIG. 9B is a timing diagram illustrating a fourth exemplary embodiment for transmission and reception of beacon frames and groupcast frames in a WLAN supporting EMLSR.

Referring to FIGS. 9A and 9B, the STA MLD 1 may be an EMLSR STA MLD, and each of the STAs affiliated with the STA MLD 1 may be an EMLSR STA. The STA MLD 1 may know a TBTT of the AP 1-1 in the first link. The STA 1-1 may transition to the EMLSR operation state before the TBTT to receive a beacon frame in the first link. In the EMLSR operation state, the STA 1-1 may receive a beacon frame from the AP 1-1. The STA 1-1 may identify a TIM (e.g., virtual bitmap) included in the beacon frame. When a bit corresponding to an AID of STA MLD 1 is set to 1 in the TIM, the STA 1-1 (e.g., STA MLD 1) may determine that a BU to be transmitted to the STA MLD 1 exists in the AP MLD 1.

In this case, the STA 1-1 may transmit a PS-Poll frame to the AP 1-1. The PS-Poll frame of the STA 1-1 may request transmission of the BU. The AP 1-1 may receive the PS-Poll frame from the STA 1-1. When the PS-Poll frame of the STA 1-1 is received, the AP 1-1 may determine that the STA 1-1 is able to receive the BU. The AP 1-1 may transmit a response frame (e.g., ACK frame) to the STA 1-1 in response to the PS-Poll frame. The response frame may be transmitted in the first link through which the PS-Poll frame is received. The STA 1-1 may receive the response frame from the AP 1-1.

The BU transmission operation of the AP 1-1 may be delayed according to a traffic condition in the first link. When the response frame for the PS-Poll frame is received, the STA 1-1 may stand by in the EMLSR operation state in the first link through which the PS-Poll frame is transmitted. Even when a data frame (e.g., BU) is not received from the AP 1-1 within a preset time (e.g., SIFS) from a reception time of the response frame for the PS-Poll frame, the STA 1-1 may maintain its operation state in the EMLSR operation state. In other words, even when it is determined that the BU transmission operation of the AP 1-1 is delayed, the STA 1-1 may maintain its operation state in the EMLSR operation state in order to receive the BU from the AP 1-1.

Until the STA 1-1 receives the BU from the AP 1-1, a frame may not be transmitted to the STA 1-2. The STA MLD 1 may be an EMLSR STA MLD. The multi-link transmission/reception function for the EMLSR STA MLD may be limited. While the STA MLD 1 operates in the EMLSR operation state in one link, the STA MLD 1 may not transmit/receive frames in other links. In other words, the STA MLD 1 may be in the blindness state in other links. Accordingly, the AP MLD 1 (e.g., AP 1-1) may transmit a response frame for the PS-Poll frame in the first link in which the STA MLD 1 (e.g., STA 1-1) operates in the EMLSR operation state. The AP MLD 1 may transmit the BU to the STA MLD 1 in the first link through which the PS-Poll frame of the STA MLD 1 is received. The STA MLD 1 may receive the BU from the AP MLD 1 in the first link.

Depending on traffic conditions or other circumstances, the AP 1-1 may not be able to transmit the BU to the STA 1-1 during a period from a transmission time of the beacon frame to a next TBTT. The STA 1-1 affiliated with the STA MLD 1 may transition to the EMLSR operation state in the next TBTT (or before the next TBTT) in the first link, and in the EMLSR operation state, the STA 1-1 may receive a beacon frame from the AP MLD 1. The STA 1-2 affiliated with the STA MLD 1 may transition to the EMLSR operation state in the next TBTT (or before the next TBTT) in the second link, and in the EMLSR operation state, the STA 1-2 may receive a beacon frame from the AP MLD 1. The AP MLD 1 may indicate whether a BU for the STA MLD 1 exists using a TIM of a beacon frame transmitted in the first link and/or the second link. When a BU for the STA MLD 1 does not exist in the AP MLD 1, a bit corresponding to the STA MLD 1 (e.g., AID of the STA MLD 1) in the TIM may be set to 0. When a BU for the STA MLD 1 exists in the AP MLD 1, the bit corresponding to the STA MLD 1 (e.g., AID of the STA MLD 1) in the TIM may be set to 1.

When the bit corresponding to the STA MLD 1 is set to 1 in the TIM of the beacon frame received from the AP MLD 1, the STA MLD 1 may transmit a PS-Poll frame in the first link and/or the second link. The AP MLD 1 may receive the PS-Poll frame from the STA MLD 1 and may transmit a response frame (e.g., ACK frame) to the STA MLD 1 in response to the PS-Poll frame. When the response frame of the AP MLD 1 is received, the STA MLD 1 may maintain the EMLSR operation state until the BU is received in the first link through which the PS-Poll frame is transmitted. When the bit corresponding to the STA MLD 1 is set to 0 in the TIM (e.g., virtual bitmap) of the beacon frame received from the AP MLD 1, the STA MLD 1 may transition to the listening operation state. In a reception procedure initiated by an MU-RTS frame, when there is no normally received frame during the time Tw, an EMLSR STA may transition to the listening operation state. In the above-described low power operation, when the TIM indicates existence of a BU for the EMLSR STA, the EMLSR STA may maintain the EMLSR operation state until receiving the BU.

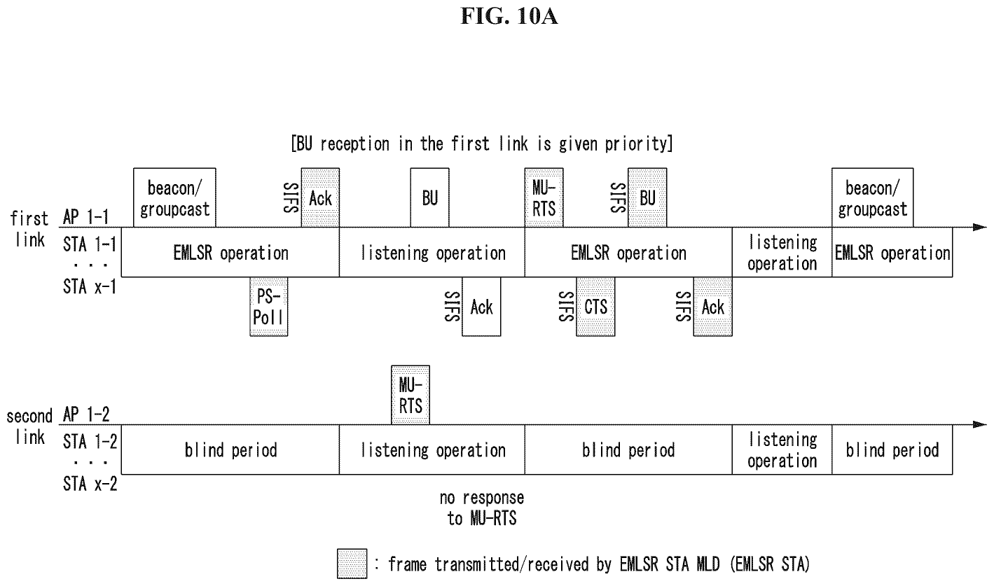

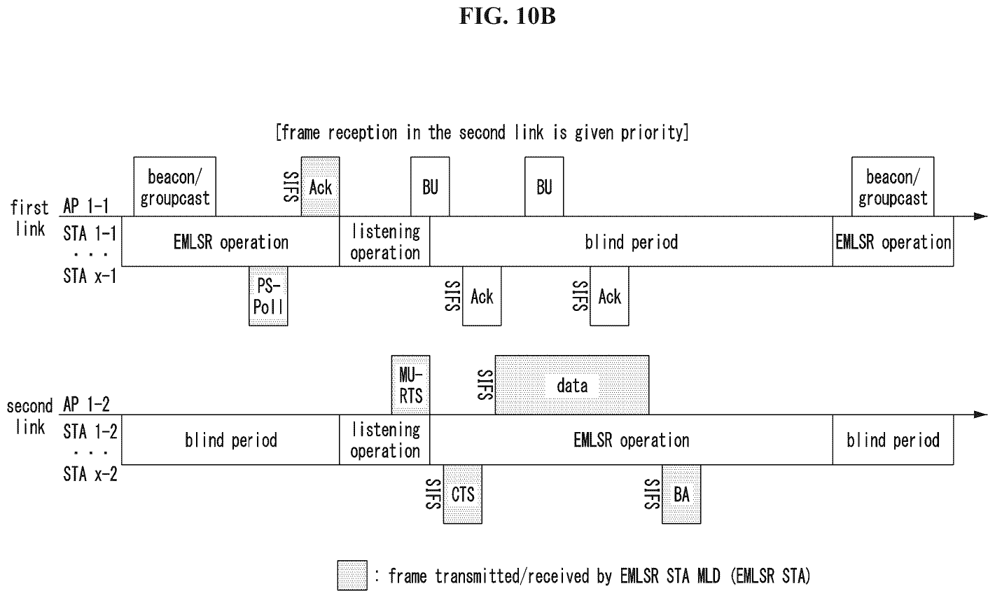

FIG. 10A is a timing diagram illustrating a fifth exemplary embodiment for transmission and reception of beacon frames and groupcast frames in a WLAN supporting EMLSR, and FIG. 10B is a timing diagram illustrating a sixth exemplary embodiment for transmission and reception of beacon frames and groupcast frames in a WLAN supporting EMLSR.

Referring to FIGS. 10A and 10B, the STA MLD 1 may be an EMLSR STA MLD, and each of the STAs affiliated with the STA MLD 1 may be an EMLSR STA. The STA MLD 1 may know a TBTT of the AP 1-1 in the first link. The STA 1-1 may transition to the EMLSR operation state before the TBTT to receive a beacon frame in the first link. In the EMLSR operation state, the STA 1-1 may receive a beacon frame from the AP 1-1. The STA 1-1 may identify a TIM (e.g., virtual bitmap) included in the beacon frame. When a bit corresponding to an AID of the STA MLD 1 is set to 1 in the TIM, the STA 1-1 (e.g., STA MLD 1) may determine that a BU to be transmitted to the STA MLD 1 exists in the AP MLD 1.

In this case, the STA 1-1 may transmit a PS-Poll frame to the AP 1-1. The PS-Poll frame of the STA 1-1 may request transmission of the BU. The AP 1-1 may receive the PS-Poll frame from the STA 1-1. When the PS-Poll frame of the STA 1-1 is received, the AP 1-1 may determine that the STA 1-1 is able to receive the BU. The AP 1-1 may transmit a response frame (e.g., ACK frame) to the STA 1-1 in response to the PS-Poll frame. The response frame may be transmitted in the first link through which the PS-Poll frame is received. The STA 1-1 may receive the response frame from the AP 1-1.

The BU transmission operation of the AP 1-1 may be delayed according to a traffic condition in the first link. When the response frame for the PS-Poll frame is received, the STA 1-1 may stand by in the listening operation state in the first link through which the PS-Poll frame is transmitted. Accordingly, when it is determined that the BU transmission operation of the AP 1-1 is delayed, the STA 1-1 may transition the operation state from the EMLSR operation state to the listening operation state. The AP MLD 1 may desire to transmit frames using multiple links (e.g., first link and second link). For example, the AP MLD 1 may desire to perform an operation of transmitting a data frame (e.g., BU) to another STA in the first link and an operation of transmitting a frame to the STA 1-2 in the second link. Since the STA MLD 1 is in the listening operation state in multiple links (e.g., first link and second link), the AP 1-2 may start downlink transmission by transmitting an initial control frame in the second link. The STA 1-2 may receive the initial control frame from the AP 1-2.

When a priority is given to the STA 1-1 affiliated with the STA MLD 1 waiting for reception of the BU in the first link (e.g., the exemplary embodiment of FIG. 10A), the STA 1-2 affiliated with the STA MLD 1 may not transmit a response (e.g., CTS frame) to the initial control frame received from the AP 1-2. Since a response to the initial control frame is not received, the AP 1-2 may not transmit a downlink frame (e.g., data frame, PPDU, MPDU, A-MPDU, or BU) to the STA 1-2. In this case, the AP 1-1 may transmit an initial control frame in the first link to transmit the BU. When a priority is given to the STA 1-2 affiliated with the STA MLD 1 waiting for reception of a frame (e.g., data frame, PPDU, MPDU, A-MPDU, BU) in the second link (e.g., the exemplary embodiment of FIG. 10B), the STA 1-2 may transmit a CTS frame in response to the initial control frame received from the AP 1-2. The CTS frame may be transmitted to the AP 1-2 after a SIFS from a reception time of the initial control frame. The AP 1-2 may receive the CTS frame from the STA 1-2, and may transmit the frame to the STA 1-2 after a SIFS from a reception time of the CTS frame. The STA 1-2 may receive the frame after a SIFS from a transmission time of the CTS frame.

The STA 1-2 may transmit a response frame (e.g., BA frame) for the frame to the AP 1-2. After a time (Tw+Ts) from a transmission time of the response frame of the STA 1-2, the STA MLD 1 may transition to the listening operation state in the first link and the second link. The STA 1-2 may operate in the listening operation state without a state transition time. The STA MLD 1 may be an EMLSR STA MLD. The multi-link transmission/reception function for the EMLSR STA MLD may be limited. The STA MLD 1 may not be able to perform a frame transmission operation and/or reception operation in the first link while performing a frame reception operation in the second link. The AP MLD 1 may not transmit a frame in the first link while transmitting a frame to the STA MLD 1 in the second link. After the STA MLD 1 transitions to the listening operation state in the first link and the second link, the AP MLD 1 may transmit the BU to the STA 1-1.

The AP 1-1 may transmit an MU-RTS frame to the STA 1-1 to transmit the BU to the STA 1-1. The STA 1-1 may receive the MU-RTS frame from the AP 1-1, and may transmit a CTS frame to the AP 1-1 after a SIFS from a reception time of the MU-RTS frame. The AP 1-1 may receive the CTS frame from the STA 1-1, and may transmit the BU to the STA 1-1 after a SIFS from a reception time of the CTS frame. The STA 1-1 may receive the BU from the STA 1-1 after a SIFS from a transmission time of the CTS frame.

Depending on traffic conditions or other circumstances, the AP 1-1 may not be able to transmit the BU to the STA 1-1. The STA MLD 1 may transition to the EMLSR operation state in a next TBTT (or before the next TBTT) of the first link or the second link. The STA MLD 1 in the EMLSR operation state may receive a beacon frame from the AP MLD 1. The AP MLD 1 may indicate whether a BU for the STA MLD 1 exists using a TIM of the beacon frame. When a BU for the STA MLD 1 does not exist in the AP MLD 1, a bit corresponding to the STA MLD 1 (e.g., AID of the STA MLD 1) in the TIM may be set to 0. When a BU for the STA MLD 1 exists in the AP MLD 1, the bit corresponding to the STA MLD 1 (e.g., AID of the STA MLD 1) in the TIM may be set to 1. When the bit corresponding to the STA MLD 1 (e.g., AID of the STA MLD 1) in the TIM is set to 1, the STA MLD 1 may transmit a PS-Poll frame in the first link or the second link. The AP MLD 1 may receive the PS-Poll frame from the STA MLD 1 and may transmit a response frame to the STA MLD 1 in response to the PS-Poll frame. The STA MLD 1 may receive the response frame from the AP MLD 1, and may transition to the listening operation state after receiving the response frame. When the bit corresponding to the STA MLD 1 (e.g., AID of the STA MLD 1) in the TIM is set to 0, the STA MLD 1 may transition to the listening operation state.

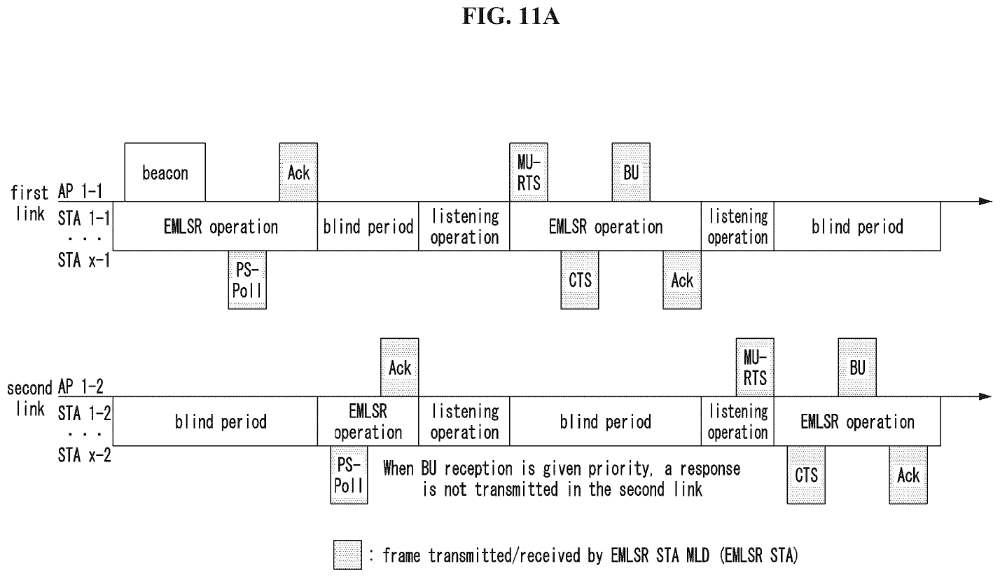

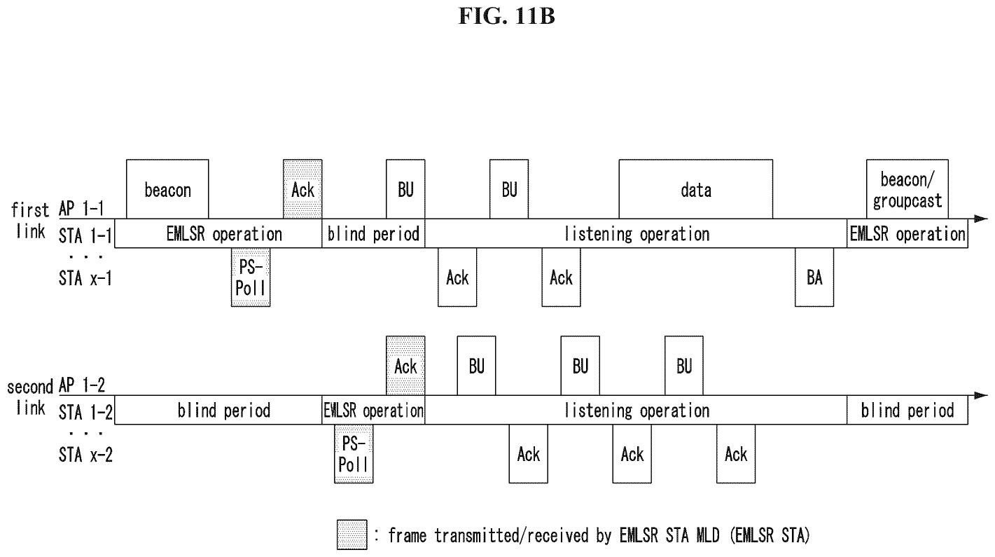

FIG. 11A is a timing diagram illustrating a seventh exemplary embodiment for transmission and reception of beacon frames and groupcast frames in a WLAN supporting EMLSR, and FIG. 11B is a timing diagram illustrating an eighth exemplary embodiment for transmission and reception of beacon frames and groupcast frames in a WLAN supporting EMLSR.

Referring to FIGS. 11A and 11B, the STA MLD 1 may be an EMLSR STA MLD, and each of the STAs affiliated with the STA MLD 1 may be an EMLSR STA. The STA MLD 1 may know a TBTT of the AP 1-1 in the first link. The STA 1-1 may transition to the EMLSR operation state before the TBTT to receive a beacon frame in the first link. In the EMLSR operation state, the STA 1-1 may receive a beacon frame from the AP 1-1. The STA 1-1 may identify a TIM (e.g., virtual bitmap) included in the beacon frame. When a bit corresponding to an AID of STA MLD 1 is set to 1 in the TIM, the STA 1-1 (e.g., STA MLD 1) may determine that a BU to be transmitted to the STA MLD 1 exists in the AP MLD 1.

In this case, the STA 1-1 may transmit a PS-Poll frame to the AP 1-1. The PS-Poll frame of the STA 1-1 may request transmission of the BU. The AP 1-1 may receive the PS-Poll frame from the STA 1-1. When the PS-Poll frame of the STA 1-1 is received, the AP 1-1 may determine that the STA 1-1 is able to receive the BU. The AP 1-1 may transmit a response frame (e.g., ACK frame) to the STA 1-1 in response to the PS-Poll frame. The response frame may be transmitted in the first link through which the PS-Poll frame is received. The STA 1-1 may receive the response frame from the AP 1-1. The STA 1-2 may perform a channel access operation in the second link, and may transmit a PS-Poll frame to the AP 1-2 when the channel access operation succeeds. The AP 1-2 may receive the PS-Poll frame from the STA 1-2 and may transmit a response frame to the STA 1-2 in response to the PS-Poll frame. The STA 1-2 may receive the response frame from the AP 1-2.

The BU transmission operation of the AP 1-1 may be delayed according to a traffic condition in the first link. The BU transmission operation of the AP 1-2 may be delayed according to a traffic condition in the second link. When the response frame for the PS-Poll frame is received, the STA 1-1 may stand by in the listening operation state in the first link through which the PS-Poll frame is transmitted to receive the BU, and the STA 1-2 may stand by in the listening operation state in the second link through which the PS-Poll frame is transmitted to receive the BU. The AP 1-1 affiliated with the AP MLD 1 may transmit the BU to the STA MLD 1 (e.g., STA 1-1) in the first link. The AP 1-2 affiliated with the AP MLD 1 may transmit the BU to the STA MLD 1 (e.g., STA 1-2) in the second link.

The AP 1-1 may transmit an initial control frame and the BU to the STA 1-1. The initial control frame may be transmitted first, and the BU may be transmitted after a response to the initial control frame is received. The STA 1-1 may receive the initial control frame and the BU from the AP 1-1, and transmit a response (e.g., CTS frame, ACK frame, BA frame, or the like) to each of the initial control frame and the BU to the AP 1-1. While the AP 1-1 transmits the frames to the STA 1-1, the AP 1-2 may not be able to transmit a frame to the STA 1-2. When the AP 1-1 completes transmission of the BU to the STA 1-1, the AP 1-2 may transmit an initial control frame and the BU to the STA 1-2 after a link transition time (e.g., Tw+Ts) of the STA MLD 1.

The initial control frame may be transmitted first, and the BU may be transmitted after a response to the initial control frame is received. The STA 1-2 may receive the initial control frame and the BU from the AP 1-2, and transmit a response (e.g., CTS frame, ACK frame, BA frame, or the like) to each of the initial control frame and the BU to the AP 1-2. While the AP 1-2 transmits the frames to the STA 1-2, the AP 1-1 may not be able to transmit a frame to the STA 1-1. An operation in which the AP 1-1 and/or AP 1-2 transmits not only the BU but also a general data frame to an EMLSR STA MLD (e.g., STA MLD 1) may be allowed. Before transmission of the BU and/or general data frame, each of the AP 1-1 and the AP 1-2 may transmit the initial control frame to the STA MLD 1.

Depending on traffic conditions or other circumstances, the AP MLD 1 may not be able to transmit the BU to the STA MLD 1 (e.g., the exemplary embodiment of FIG. 11B). The STA MLD 1 may transition to the EMLSR operation state in a next TBTT (or before the next TBTT) of the first link or the second link. The STA MLD 1 in the EMLSR operation state may receive a beacon frame from the AP MLD 1. The AP MLD 1 may indicate whether a BU for the STA MLD 1 exists using a TIM of the beacon frame. When a BU for the STA MLD 1 does not exist in the AP MLD 1, a bit corresponding to the STA MLD 1 (e.g., AID of the STA MLD 1) in the TIM may be set to 0. When a BU for the STA MLD 1 exists in the AP MLD 1, the bit corresponding to the STA MLD 1 (e.g., AID of the STA MLD 1) in the TIM may be set to 1. When the bit corresponding to the STA MLD 1 (e.g., AID of the STA MLD 1) in the TIM is set to 1, the STA MLD 1 may transmit a PS-Poll frame in the first link or the second link. The AP MLD 1 may receive the PS-Poll frame from the STA MLD 1 and may transmit a response frame to the STA MLD 1 in response to the PS-Poll frame. The STA MLD 1 may receive the response frame from the AP MLD 1, and may transition to the listening operation state after receiving the response frame. When the bit corresponding to the STA MLD 1 (e.g., AID of the STA MLD 1) in the TIM is set to 0, the STA MLD 1 may transition to the listening operation state.

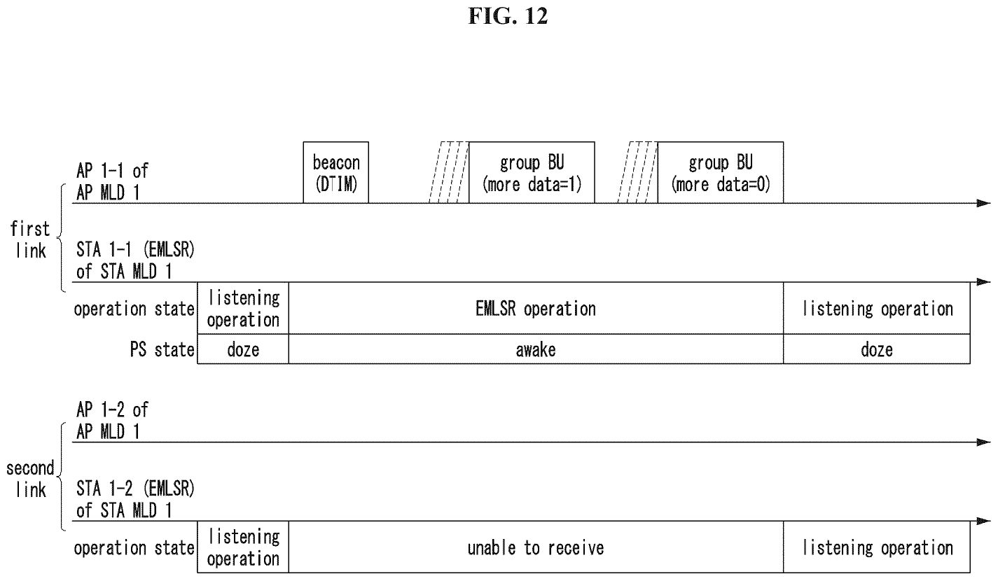

FIG. 12 is a timing diagram illustrating a ninth exemplary embodiment for transmission and reception of beacon frames and groupcast frames in a WLAN supporting EMLSR.

Referring to FIG. 12, the STA MLD 1 may be an EMLSR STA MLD, and each of the STAs affiliated with the STA MLD 1 may be an EMLSR STA. The STA MLD 1 may know a TBTT of the AP 1-1 in the first link. The STA 1-1 may transition to the EMLSR operation state before the TBTT to receive a beacon frame in the first link. In other words, the operation state of the STA 1-1 may transition from the listening operation state to the EMLSR operation state. The STA 1-1 may transition to an awake state before the TBTT to receive a beacon frame in the first link. In other words, a power saving (PS) state of the STA 1-1 may transition from a doze state to the awake state. In the doze state, a STA (e.g., STA 1-1) may use minimum power, and transmission/reception operations of the STA may be impossible. In the awake state, transmission/reception operations of the STA may be possible.

The operation state (e.g., listening operation state, EMLSR operation state) and the PS state (e.g., awake state, doze state) of the STA may be configured independently. When the STA is in the EMLSR operation state, the STA may be in the awake state. When the STA is in the listening operation state, the STA may be in the awake state or the doze state. Depending on the operation state and/or PS state, transmission/reception operations of a frame (e.g., general frame, normal frame), reception operation of a specific frame (e.g., initial control frame, MU-RTS frame), or transmission operation of a specific frame may be possible. Alternatively, transmission/reception operation of a frame may be impossible depending on the operation state and/or the PS state.

The STA 1-1 in the EMLSR operation state may receive the beacon frame from the AP 1-1 in the first link. The beacon frame transmitted by the AP 1-1 may include a delivery traffic indication map (DTIM) or TIM. The DTIM (or TIM) may include information (e.g., AID bitmap, link bitmap associated with the AID bitmap) indicating that the STA 1-1 receives a groupcast BU or group addressed BU in the first link. Each of the groupcast BU and the group addressed BU may be referred to as a group BU. The DTIM of the beacon frame transmitted by the AP 1-1 may include information indicating that the STA 1-1 receives the group BU in the first link. In other words, the DTIM may indicate that a BU (e.g., group BU) to be transmitted to the STA 1-1 exists in the AP 1-1.

The STA MLD 1 may identify the DTIM received from the AP 1-1, and based on a result of identifying the DTIM, the STA MLD 1 may know that the STA 1-1 needs to receive the group BU in the first link. Accordingly, the STA 1-1 affiliated with the STA MLD 1 may maintain the EMLSR operation state for reception of the group BU in the first link, and the STA 1-1 may maintain its PS state in the awake state.

The AP 1-1 may transmit the group BU to a plurality of STAs including the STA 1-1. A ‘more data’ bit included in a MAC header of a first group BU of the AP 1-1 may be set to 1. In this case, the STA 1-1 may maintain the EMLSR operation state and the awake state in order to receive a next group BU. A ‘more data’ bit included in a MAC header of a second group BU of the AP 1-1 may be set to 0. In this case, the STA 1-1 may determine that a group BU to be transmitted to the STA 1-1 does not exist. Accordingly, the STA 1-1 may transition the operation state from the EMLSR operation state to the listening operation state. In addition, the STA 1-1 may transition the PS state from the awake state to the doze state. The AP 1-1 may not transmit an additional group BU after transmitting the second group BU including the ‘more data’ bit set to 0.

When a group BU is not received, the STA 1-1 may wait for reception of a next beacon frame from the AP 1-1. The STA 1-1 may receive the next beacon frame from the AP 1-1. When a TIM or DTIM included in the next beacon frame does not indicate that there is a BU to be transmitted to the STA 1-1, the STA 1-1 may determine that a group BU to be received does not exist. Accordingly, the STA 1-1 may transition the operation state from the EMLSR operation state to the listening operation state, and may transition the PS state from the awake state to the doze state. When the TIM or DTIM included in the next beacon frame indicates that there is a BU to be transmitted to the STA 1-1, the STA 1-1 may determine that a group BU to be received exists. Accordingly, the STA 1-1 may maintain the operation state in the EMLSR operation state and maintain the PS state in the awake state.

When the operation state of the STA 1-1 in the first link is the EMLSR operation state, transmission and reception operations of the STA 1-2 in the second link may be impossible. When the TIM or DTIM included in the beacon frame transmitted in the first link indicates that there is a group BU to be transmitted to the STA 1-1, the AP 1-2 may not transmit a frame to the STA 1-2 in the second link. While the AP 1-1 transmits the group BU in the first link, the AP 1-2 may not transmit a frame (e.g., data frame, PPDU, MPDU, A-MPDU, BU, or the like) to the STA 1-2 in the second link. The AP 1-2 may transmit a frame to the STA 1-2 after the transmission operation of the group BU of the AP 1-1 is completed.

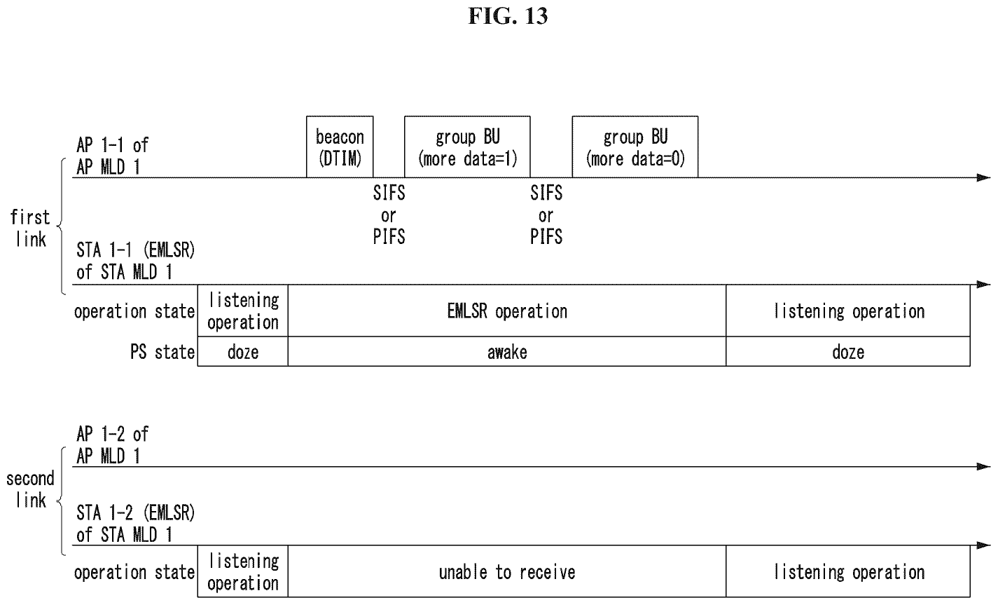

FIG. 13 is a timing diagram illustrating a tenth exemplary embodiment for transmission and reception of beacon frames and groupcast frames in a WLAN supporting EMLSR.

Referring to FIG. 13, the STA MLD 1 may be an EMLSR STA MLD, and each of the STAs affiliated with the STA MLD 1 may be an EMLSR STA. The STA MLD 1 may know a TBTT of the AP 1-1 in the first link. The STA 1-1 may transition to the EMLSR operation state before the TBTT to receive a beacon frame in the first link. In other words, the operation state of the STA 1-1 may transition from the listening operation state to the EMLSR operation state. The STA 1-1 may transition to the awake state before the TBTT to receive the beacon frame in the first link. In other words, the PS state of the STA 1-1 may transition from the doze state to the awake state. In the doze state, a STA (e.g., STA 1-1) may use minimum power, and transmission/reception operations of the STA may be impossible. In the awake state, transmission/reception operations of the STA may be possible.

The operation state (e.g., listening operation state, EMLSR operation state) and the PS state (e.g., awake state, doze state) of the STA may be configured independently. Depending on the operation state and/or the PS state, transmission/reception operations of a frame (e.g., general frame, normal frame), reception operation of a specific frame (e.g., initial control frame, MU-RTS frame), or transmission operation of a specific frame may be possible. Alternatively, a transmission/reception operation of a frame may be impossible depending on the operation state and/or the PS state.

The STA 1-1 in the EMLSR operation state may receive the beacon frame from the AP 1-1 in the first link. The beacon frame transmitted by the AP 1-1 may include a DTIM. The DTIM may include information (e.g., AID bitmap, link bitmap associated with the AID bitmap) indicating that the STA 1-1 receives a group BU (e.g., groupcast BU or group addressed BU) in the first link. The DTIM of the beacon frame transmitted by the AP 1-1 may include information indicating that the STA 1-1 receives the group BU in the first link. In other words, the DTIM may indicate that a BU (e.g., group BU) to be transmitted to the STA 1-1 exists in the AP 1-1.

The STA MLD 1 may identify the DTIM received from the AP 1-1, and based on a result of identifying the DTIM, the STA MLD 1 may know that the STA 1-1 needs to receive the group BU in the first link. The STA 1-1 affiliated with the STA MLD 1 (e.g., EMLSR STA MLD) may transition to the listening operation state when a PHY-RXSTART.indication does not occur during a transition waiting time (e.g., aSIFSTime+aSlotTime+aRxPHYStartDelay). In other words, the operation state of the STA 1-1 may transition from the EMLSR operation state to the listening operation state. The PHY-RXSTART.indication may be a physical layer primitive. The transition waiting time may be longer than a SIFS or PIFS. The AP 1-1 may transmit frames (e.g., beacon frame, group BU) at SIFS or PIFS intervals. For example, the AP 1-1 may transmit group BUs at SIFS and/or PIFS intervals after transmitting the beacon frame.

Since the reception operation of the group BU is performed within the transition waiting time, the PHY-RXSTART.indication may occur in the STA 1-1 within the transition waiting time. The STA 1-1 may maintain the EMLSR operation state while receiving the group BUs. The AP 1-1 may transmit the group BUs to a plurality of STAs including the STA 1-1. A ‘more data’ bit included in a MAC header of a first group BU of the AP 1-1 may be set to 1. In this case, the STA 1-1 may maintain the EMLSR operation state and the awake state in order to receive a next group BU. A ‘more data’ bit included in a MAC header of a second group BU of the AP 1-1 may be set to 0. In this case, the STA 1-1 may determine that a group BU to be transmitted to the STA 1-1 does not exist. Accordingly, the STA 1-1 may transition the operation state from the EMLSR operation state to the listening operation state. Alternatively, when a PHY-RXSTART.indication does not occur in the STA 1-1 within a transition waiting time, the STA 1-1 may transition the operation state from the EMLSR operation state to the listening operation state. When reception of the group BU(s) is completed, the STA 1-1 may transition the PS state from the awake state to the doze state.

When the operation state of the STA 1-1 in the first link is the EMLSR operation state, transmission and reception operations of the STA 1-2 in the second link may be impossible. When a TIM or DTIM included in a beacon frame transmitted in the first link indicates that there is a group BU to be transmitted to the STA 1-1, the AP 1-2 may not transmit a frame to the STA 1-2 in the second link. While the AP 1-1 transmits the group BU in the first link, the AP 1-2 may not transmit a frame (e.g., data frame, PPDU, MPDU, A-MPDU, BU, or the like) to the STA 1-2 in the second link. The AP 1-2 may transmit a frame to the STA 1-2 after the transmission operation of the group BU of the AP 1-1 is completed.

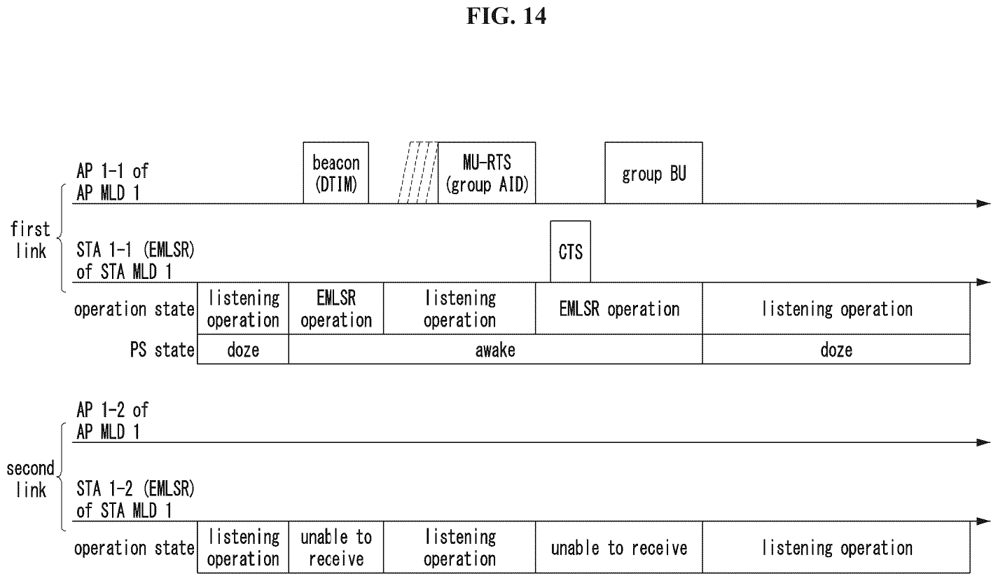

FIG. 14 is a timing diagram illustrating an eleventh exemplary embodiment for transmission and reception of beacon frames and groupcast frames in a WLAN supporting EMLSR.

Referring to FIG. 14, the STA MLD 1 may be an EMLSR STA MLD, and each of the STAs affiliated with the STA MLD 1 may be an EMLSR STA. The STA MLD 1 may know a TBTT of the AP 1-1 in the first link. The STA 1-1 may transition to the EMLSR operation state before the TBTT to receive a beacon frame in the first link. In other words, the operation state of the STA 1-1 may transition from the listening operation state to the EMLSR operation state. The STA 1-1 may transition to the awake state before the TBTT to receive the beacon frame in the first link. In other words, the PS state of the STA 1-1 may transition from the doze state to the awake state. In the doze state, a STA (e.g., STA 1-1) may use minimum power, and transmission/reception operations of the STA may be impossible. In the awake state, transmission/reception operations of the STA may be possible.

The operation state (e.g., listening operation state, EMLSR operation state) and the PS state (e.g., awake state, doze state) of the STA may be configured independently. Depending on the operation state and/or the PS state, transmission/reception operations of a frame (e.g., general frame, normal frame), reception operations of a specific frame (e.g., initial control frame, MU-RTS frame), or transmission operations of a specific frame may be possible. Alternatively, transmission/reception operations of a frame may be impossible depending on the operation state and/or the PS state.

The STA 1-1 in the EMLSR operation state may receive the beacon frame from the AP 1-1 in the first link. The beacon frame transmitted by the AP 1-1 may include a DTIM. The DTIM may include information (e.g., AID bitmap, link bitmap associated with the AID bitmap) indicating that the STA 1-1 receives a group BU (e.g., groupcast BU or group addressed BU) in the first link. Each of the groupcast BU and the group addressed BU may be referred to as a group BU. The DTIM of the beacon frame transmitted by the AP 1-1 may include information indicating that the STA 1-1 receives the group BU in the first link. In other words, the DTIM may indicate that a BU (e.g., group BU) to be transmitted to the STA 1-1 exists in the AP 1-1.

The STA MLD 1 may identify the DTIM received from the AP 1-1, and based on a result of identifying the DTIM, the STA MLD 1 may know that the STA 1-1 needs to receive the group BU in the first link. The STA 1-1 affiliated with the STA MLD 1 (e.g., EMLSR STA MLD) may transition to the listening operation state when a PHY-RXSTART.indication does not occur during a transition waiting time (e.g., aSIFSTime+aSlotTime+aRxPHYStartDelay). In other words, the operation state of the STA 1-1 may transition from the EMLSR operation state to the listening operation state. The transition waiting time may be longer than a SIFS or PIFS. The STA 1-1 may maintain the PS state in the awake state until reception of the group BU is completed.

The AP 1-1 may first transmit an initial control frame (e.g., MU-RTS frame) to transmit the group BU. An AID included in a user information field of the MU-RTS frame of the AP 1-1 may indicate a group. In other words, the AID included in the user information field may be a group AID. Alternatively, the MU-RTS frame of the AP 1-1 may include a plurality of user information fields, and the MU-RTS frame (e.g., the plurality of user information fields) may indicate a plurality of AIDs. For example, the plurality of AIDs corresponding to the number of STAs that need to receive the group BU may be included in the MU-RTS frame, and the plurality of AIDs may include an AID of the STA 1-1. The STA 1-1 may receive the initial control frame from the AP 1-1 and may identify the user information field(s) of the initial control frame. When the AID included in the user information field indicates a group (e.g., when the user information field includes a group AID), the STA 1-1 may transition the operation state from the listening operation state to the EMLSR operation state. A plurality of STAs including the STA 1-1 may transmit CTS frames (e.g., simultaneous (S)-CTS frames) to the AP 1-1 after a SIFS from a reception time of the MU-RTS frame (e.g., initial control frame).

The AP 1-1 may receive the CTS frame, and may transmit the group BUs to the plurality of STAs after receiving the CTS frame. The Group BUs may be transmitted consecutively as in the exemplary embodiment of FIG. 12 or FIG. 13. Alternatively, the group BUs may be transmitted consecutively within a TXOP configured by the AP 1-1. The TXOP may be configured by the MU-RTS frame transmitted by the AP 1-1. The group BUs may be transmitted at SIF intervals within the TXOP.

A ‘more data’ field included in a MAC header of the last group BU (e.g., the last data frame) transmitted by the AP 1-1 may be set to 0. When the more data field included in the last group BU is set to 0, the STA 1-1 may determine that there is no group BU to be received after the last group BU. Accordingly, the STA 1-1 may transition the operation state from the EMLSR operation state to the listening operation state after receiving the last group BU. Alternatively, when a PHY-RXSTART.indication does not occur in th STA 1-1 within a transition waiting time, the STA 1-1 may transition the operation state from the EMLSR operation state to the listening operation state. When reception of the group BU(s) is completed, the STA 1-1 may transition the PS state from the awake state to the doze state.

When the operation state of the STA 1-1 in the first link is the EMLSR operation state, transmission and reception operations of the STA 1-2 in the second link may be impossible. When the TIM or DTIM included in the beacon frame transmitted in the first link indicates that there is a group BU to be transmitted to the STA 1-1, the AP 1-2 may not transmit a frame to the STA 1-2 in the second link. While the AP 1-1 transmits the group BU in the first link, the AP 1-2 may not transmit a frame (e.g., data frame, PPDU, MPDU, A-MPDU, BU, or the like) to the STA 1-2 in the second link. The AP 1-2 may transmit a frame to the STA 1-2 after the transmission operation of the group BU of the AP 1-1 is completed.

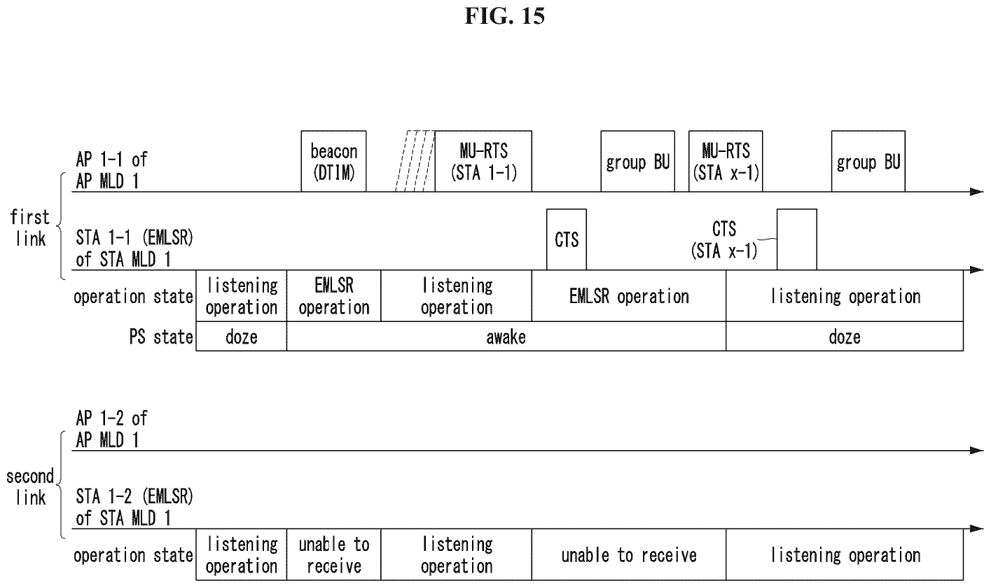

FIG. 15 is a timing diagram illustrating a twelfth exemplary embodiment for transmission and reception of beacon frames and groupcast frames in a WLAN supporting EMLSR.

Referring to FIG. 15, the STA MLD 1 may be an EMLSR STA MLD, and each of the STAs affiliated with the STA MLD 1 may be an EMLSR STA. The STA MLD 1 may know a TBTT of the AP 1-1 in the first link. The STA 1-1 may transition to the EMLSR operation state before the TBTT to receive a beacon frame in the first link. In other words, the operation state of the STA 1-1 may transition from the listening operation state to the EMLSR operation state. The STA 1-1 may transition to the awake state before the TBTT to receive the beacon frame in the first link. In other words, the PS state of the STA 1-1 may transition from the doze state to the awake state. In the doze state, a STA (e.g., STA 1-1) may use minimum power, and transmission/reception operations of the STA may be impossible. In the awake state, transmission/reception operations of the STA may be possible.

The operation state (e.g., listening operation state, EMLSR operation state) and the PS state (e.g., awake state, doze state) of the STA may be configured independently. Depending on the operation state and/or the PS state, transmission/reception operations of a frame (e.g., general frame, normal frame), reception operations of a specific frame (e.g., initial control frame, MU-RTS frame), or transmission operations of a specific frame may be possible. Alternatively, transmission/reception operations of a frame may be impossible depending on the operation state and/or the PS state.

The STA 1-1 in the EMLSR operation state may receive the beacon frame from the AP 1-1 in the first link. The beacon frame transmitted by the AP 1-1 may include a DTIM. The DTIM may include information (e.g., AID bitmap, a link bitmap associated with the AID bitmap) indicating that the STA 1-1 receives a group BU or group addressed BU in the first link. Each of the groupcast BU and the group addressed BU may be referred to as a group BU. The DTIM of the beacon frame transmitted by the AP 1-1 may include information indicating that the STA 1-1 receives the group BU in the first link. In other words, the DTIM may indicate that a BU (e.g., group BU) to be transmitted to the STA 1-1 exists in the AP 1-1.

The STA MLD 1 may identify the DTIM received from the AP 1-1, and based on a result of identifying the DTIM, the STA MLD 1 may know that the STA 1-1 needs to receive the group BU in the first link. The STA 1-1 affiliated with the STA MLD 1 (e.g., EMLSR STA MLD) may transition to the listening operation state when a PHY-RXSTART.indication does not occur during a transition waiting time (e.g., aSIFSTime+aSlotTime+aRxPHYStartDelay). In other words, the operation state of the STA 1-1 may transition from the EMLSR operation state to the listening operation state. The transition waiting time may be longer than a SIFS or PIFS. The STA 1-1 may maintain the PS state in the awake state until reception of the group BU is completed.

The AP 1-1 may first transmit an initial control frame (e.g., MU-RTS frame) to transmit the group BU. An AID included in a user information field of the MU-RTS frame of the AP 1-1 may indicate an AID of the STA 1-1. The STA 1-1 may receive the initial control frame from the AP 1-1 and may identify the user information field of the initial control frame. When the AID included in the user information field indicates the AID of the STA 1-1, the STA 1-1 may transition the operation state from the listening operation state to the EMLSR operation state. The STA 1-1 may transmit a CTS frame (e.g., simultaneous (S)-CTS frame) to the AP 1-1 after a SIFS from a reception time of the MU-RTS frame (e.g., initial control frame).

The AP 1-1 may receive the CTS frame, and may transmit the group BU to the STA 1-1 after receiving the CTS frame. The STA 1-1 may receive the group BU from the AP 1-1 and may transmit a response frame to the AP 1-1 in response to the group BU. Alternatively, the STA 1-1 may not transmit a response frame to the AP 1-1 in response to the group BU. A ‘more data’ field included in a MAC header of the last group BU (e.g., the last data frame) transmitted by the AP 1-1 may be set to 0. When the ‘more data’ field included in the last group BU is set to 0, the STA 1-1 may determine that there is no group BU to be received after the last group BU. Accordingly, the STA 1-1 may transition the operation state from the EMLSR operation state to the listening operation state after receiving the last group BU.

Alternatively, when a PHY-RXSTART.indication does not occur in th STA 1-1 within a transition waiting time, the STA 1-1 may transition the operation state from the EMLSR operation state to the listening operation state. When reception of the group BU(s) is completed, the STA 1-1 may transition the PS state from the awake state to the doze state. The AP 1-1 may repeatedly perform the above-described operations for other EMLSR STA(s). The AP 1-1 may generate a user information field including an AID of another STA x-1 other than the STA 1-1, and may transmit an MU-RTS frame including the user information field. The STA x-1 may receive a group BU from the AP 1-1 by performing the above-described operations (e.g., operations of the STA 1-1).

When the operation state of the STA 1-1 in the first link is the EMLSR operation state, transmission and reception operations of the STA 1-2 in the second link may be impossible. When the TIM or DTIM included in the beacon frame transmitted in the first link indicates that there is a group BU to be transmitted to the STA 1-1, the AP 1-2 may not transmit a frame to the STA 1-2 in the second link. While the AP 1-1 transmits the group BU in the first link, the AP 1-2 may not transmit a frame (e.g., data frame, PPDU, MPDU, A-MPDU, BU, or the like) to the STA 1-2 in the second link. The AP 1-2 may transmit a frame to the STA 1-2 after the transmission operation of the group BU of the AP 1-1 is completed.

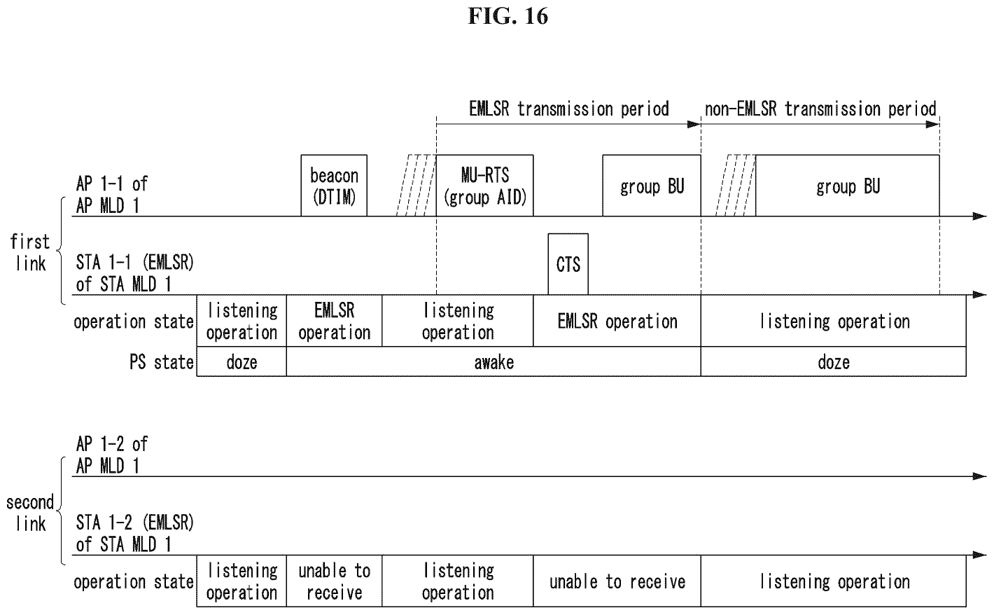

FIG. 16 is a timing diagram illustrating a thirteenth exemplary embodiment for transmission and reception of beacon frames and groupcast frames in a WLAN supporting EMLSR.

Referring to FIG. 16, the STA MLD 1 may be an EMLSR STA MLD, and each of the STAs affiliated with the STA MLD 1 may be an EMLSR STA. The STA MLD 1 may know a TBTT of the AP 1-1 in the first link. The STA 1-1 may transition to the EMLSR operation state before the TBTT to receive a beacon frame in the first link. In other words, the operation state of the STA 1-1 may transition from the listening operation state to the EMLSR operation state. The STA 1-1 may transition to the awake state before the TBTT to receive the beacon frame in the first link. In other words, the PS state of the STA 1-1 may transition from the doze state to the awake state. In the doze state, a STA (e.g., STA 1-1) may use minimum power, and transmission/reception operations of the STA may be impossible. In the awake state, transmission/reception operations of the STA may be possible.

The operation state (e.g., listening operation state, EMLSR operation state) and the PS state (e.g., awake state, doze state) of the STA may be configured independently. Depending on the operation state and/or the PS state, transmission/reception operations of a frame (e.g., general frame, normal frame), reception operations of a specific frame (e.g., initial control frame, MU-RTS frame), or transmission operations of a specific frame may be possible. Alternatively, transmission/reception operations of a frame may be impossible depending on the operation state and/or the PS state.

The STA 1-1 in the EMLSR operation state may receive the beacon frame from the AP 1-1 in the first link. The beacon frame transmitted by the AP 1-1 may include a DTIM. The DTIM may include information (e.g., AID bitmap, a link bitmap associated with the AID bitmap) indicating that the STA 1-1 receives a group BU or group addressed BU in the first link. Each of the groupcast BU and the group addressed BU may be referred to as a group BU. The DTIM of the beacon frame transmitted by the AP 1-1 may include information indicating that the STA 1-1 receives the group BU in the first link. In other words, the DTIM may indicate that a BU (e.g., group BU) to be transmitted to the STA 1-1 exists in the AP 1-1.

The STA MLD 1 may identify the DTIM received from the AP 1-1, and based on a result of identifying the DTIM, the STA MLD 1 may know that the STA 1-1 needs to receive the group BU in the first link. The STA 1-1 affiliated with the STA MLD 1 (e.g., EMLSR STA MLD) may transition to the listening operation state when a PHY-RXSTART.indication does not occur during a transition waiting time (e.g., aSIFSTime+aSlotTime+aRxPHYStartDelay). In other words, the operation state of the STA 1-1 may transition from the EMLSR operation state to the listening operation state. The transition waiting time may be longer than a SIFS or PIFS. The STA 1-1 may maintain the PS state in the awake state until reception of the group BU is completed.

Reception target(s) of the group BU may be classified into an EMLSR group including STA(s) affiliated with the EMLSR STA MLD and a non-EMLSR group including STA(s) not affiliated with the EMLSR STA MLD. In this case, a transmission period of the group BU may be classified into an EMLSR transmission period and a non-EMLSR transmission period. The AP 1-1 may transmit the group BU to the EMLSR group in the EMLSR transmission period. In order to transmit the group BU in the EMLSR transmission period, the exemplary embodiment of FIG. 13 or FIG. 14 may be used. The AP 1-1 may transmit the group BU to the non-EMLSR group in the non-EMLSR transmission period. In the non-EMLSR transmission period, the AP 1-1 may transmit the group BU without transmitting an initial control frame.

In the time domain, the EMLSR transmission period may be located earlier than the non-EMLSR transmission period. In this case, the AP 1-1 may transmit the group BU first in the EMLSR transmission period, and may transmit the group BU in the non-EMLSR transmission period after the EMLSR transmission period. Alternatively, in the time domain, the non-EMLSR transmission period may be located earlier than the EMLSR transmission period. In this case, the AP 1-1 may transmit the group BU first in the non-EMLSR transmission period, and may transmit the group BU in the EMLSR transmission period after the non-EMLSR transmission period. The EMLSR transmission period and the non-EMLSR transmission period may be repeated until transmission of the group BU is completed. While the AP 1-1 transmits the group BU in the first link, the AP 1-2 may not transmit a frame (e.g., data frame, PPDU, MPDU, A-MPDU, BU, or the like) to the STA 1-2 in the second link. The AP 1-2 may transmit a frame to the STA 1-2 after the transmission operation the group BU of the AP 1-1 is completed (e.g., after the EMLSR transmission periods ends).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first station (STA), comprising:
transitioning an operation state of the first STA from a listening operation state to an enhanced multi-link single radio (EMLSR) operation state in consideration of a target beacon transmission time (TBTT) of a first access point (AP);
receiving, from the first AP, a beacon frame in the EMLSR operation state;
in response to the beacon frame indicating that a data unit to be transmitted to the first STA exists in the first AP, transmitting a power saving (PS)-Poll frame to the first AP; and
receiving, from the first AP, a data frame including the data unit in the EMLSR operation state.

2. The method according to claim 1, further comprising:
in response to determining that transmission of the data unit is delayed after transmitting the PS-Poll frame, transitioning the operation state of the first STA from the EMLSR operation state to the listening operation state;
receiving, from the first AP, an initial control frame in the listening operation state; and
after receiving the initial control frame, transitioning the operation state of the first STA from the listening operation state to the EMLSR operation state,
wherein the data frame is received by the first STA operating in the EMLSR operation state after receiving the initial control frame.

3. The method according to claim 2, wherein the initial control frame is a multi-user (MU)-request-to-send (RTS) frame, a clear-to-send (CTS) frame as a response to the MU-RTS frame is transmitted by the first STA, and the data frame is received after transmitting the CTS frame.

4. The method according to claim 2, wherein when an acknowledgment (ACK) frame is received in response to the PS-Poll and the data frame is not received within a preset time from a reception time of the ACK frame, transmission of the data unit is determined to be delayed.

5. The method according to claim 2, wherein when an ACK frame is received instead of the data frame in response to the PS-Poll frame, transmission of the data unit is determined to be delayed.

6. The method according to claim 1, wherein when transmission of the data unit is determined to be delayed after transmitting the PS-Poll frame, the operation state of the first STA is maintained in the EMLSR operation state for reception of the data frame.

7. The method according to claim 1, wherein the first STA and a second STA are affiliated with a STA multi-link device (MLD), the STA MLD is an EMLSR STA MLD, the first AP and a second AP are affiliated with an AP MLD, the first STA and the first AP operate in a first link, and the second STA and the second AP operate in a second link.

8. The method according to claim 7, wherein when reception of the data unit in the first link is given priority and the second STA receives an initial control frame in the second link after the PS-Poll frame is transmitted in the first link, a response to the initial control frame is not transmitted.

9. The method according to claim 1, wherein when the first STA is in the EMLSR operation state, a power saving (PS) state of the first STA is an awake state, and when the first STA is in the listening operation state, the PS state of the first STA is a doze state or the awake state.

10. A method of a first access point (AP), comprising:
transmitting a beacon frame including information indicating that a data unit to be transmitted to a first station (STA) exists in the first AP;
receiving a power saving (PS)-Poll frame from the first STA operating in an enhanced multi-link single radio (EMLSR) operation state; and
transmitting a data frame including the data unit to the first STA operating in the EMLSR operation state,
wherein an operation state of the first STA is the EMLSR operation state or a listening operation state.

11. The method according to claim 10, further comprising: in response to determining that the operation state of the first STA has transitioned from the EMLSR operation state to the listening operation state after the PS-Poll frame is received, transmitting an initial control frame to the first STA operating in the listening operation state, wherein the data frame is transmitted to the first STA operating in the EMLSR operation state, according to the initial control frame.

12. The method according to claim 11, wherein the initial control frame is a multi-user (MU)-request-to-send (RTS) frame, a clear-to-send (CTS) frame as a response to the MU-RTS frame is received from the first STA, and the data frame is transmitted after receiving the CTS frame.

13. The method according to claim 11, wherein when an acknowledgment (ACK) frame is transmitted in response to the PS-Poll and the first AP does not transmit the data frame within a preset time from a transmission time of the ACK frame, the operation state of the first STA is determined to have been transitioned from the EMLSR operation state to the listening operation state.

14. The method according to claim 11, wherein when the first AP transmits an ACK frame instead of the data frame in response to the PS-Poll frame, the operation state of the first STA is determined to have been transitioned from the EMLSR operation state to the listening operation state.

15. A first station (STA) comprising a processor, wherein the processor causes the first STA to perform:
transitioning an operation state of the first STA from a listening operation state to an enhanced multi-link single radio (EMLSR) operation state in consideration of a target beacon transmission time (TBTT) of a first access point (AP);
receiving, from the first AP, a beacon frame in the EMLSR operation state;
in response to the beacon frame indicating that a data unit to be transmitted to the first STA exists in the first AP, transmitting a power saving (PS)-Poll frame to the first AP; and
receiving, from the first AP, a data frame including the data unit in the EMLSR operation state.

16. The first STA according to claim 15, wherein the processor causes the first STA to perform:
in response to determining that transmission of the data unit is delayed after transmitting the PS-Poll frame, transitioning the operation state of the first STA from the EMLSR operation state to the listening operation state;
receiving, from the first AP, an initial control frame in the listening operation state; and
after receiving the initial control frame, transitioning the operation state of the first STA from the listening operation state to the EMLSR operation state,
wherein the data frame is received by the first STA operating in the EMLSR operation state after receiving the initial control frame.

17. The first STA according to claim 16, wherein the initial control frame is a multi-user (MU)-request-to-send (RTS) frame, a clear-to-send (CTS) frame as a response to the MU-RTS frame is transmitted by the first STA, and the data frame is received after transmitting the CTS frame.

18. The first STA according to claim 15, wherein when transmission of the data unit is determined to be delayed after transmitting the PS-Poll frame, the operation state of the first STA is maintained in the EMLSR operation state for reception of the data frame.

19. The first STA according to claim 15, wherein the first STA and a second STA are affiliated with a STA multi-link device (MLD), the STA MLD is an EMLSR STA MLD, the first AP and a second AP are affiliated with an AP MLD, the first STA and the first AP operate in a first link, and the second STA and the second AP operate in a second link.

20. The first STA according to claim 19, wherein when reception of the data unit in the first link is given priority and the second STA receives an initial control frame in the second link after the PS-Poll frame is transmitted in the first link, a response to the initial control frame is not transmitted.
